(19) United States
(12) Patent Application Publication
(10) Pub. No.: US 2026/0192139 A1
(43) Pub. Date: Jul. 9, 2026

(54) CONTROLLING OPERATION OF AERIAL VEHICLES FOR ACOUSTIC EXTINGUISHING OF FIRE

(71) Applicant: International Business Machines Corporation, Armonk, NY (US)

(72) Inventors: Dhruv Khurana, Marietta, GA (US); Radha Mohan De, Howrah (IN); Sasanka Sahu, Bangalore (IN); Renganathan Sundararaman, Cary, NC (US); Swaminathan Balasubramanian, Troy, MI (US)

(21) Appl. No.: 19/008,693

(22) Filed: Jan. 3, 2025

(51) Int. Cl. A62C 3/00; A62C 37/00; G05D 1/69; G05D 1/86; G05D 101/10; G05D 105/55; G05D 109/20; G05D 111/10; G05D 111/20; G05D 111/50

(52) U.S. Cl. CPC A62C 3/00; A62C 37/00; G05D 1/69; G05D 1/86; G05D 2101/10; G05D 2105/55; G05D 2109/20; G05D 2111/10; G05D 2111/20; G05D 2111/52

(57) ABSTRACT

Generation of control instruction to control operation of aerial vehicle includes receiving fire-bound area data associated with a fire within a fire-bound area. The fire-bound area data includes image data, environment data, geospatial data, and fire magnitude data. Further, an artificial intelligence (AI) model is applied to the fire-bound area data. Requirement data is determined to acoustically extinguish the fire. The requirement data is indicative of a count associated with a set of aerial vehicles of a plurality of aerial vehicles and one or more operating parameters associated with each aerial vehicle of the set of aerial vehicles. A set of control instructions is generated based on the requirement data. Further, the set of control instructions associated with each aerial vehicle of the set of aerial vehicles is output.

### BACKGROUND

The disclosure relates to generation of control instructions for aerial vehicles.

Fires are a critical threat to human life, property, and the environment, resulting in extensive damage across cities, forests, and industrial areas. The increasing frequency and intensity of wildfires, driven by factors such as climate change, urban expansion, and human activities, necessitate the development of firefighting solutions. Traditional firefighting methodologies, including the application of water, chemical agents, and dry powders, have been found inadequate in addressing various fire scenarios, particularly in challenging or inaccessible locations, as well as under bad weather conditions.

Firefighters face many challenges, including difficult terrain, rapidly changing environmental conditions, and the extensive scale of large fires. Conventional techniques usually require firefighters to have direct access to flames, which may be dangerous or impractical in certain situations. Additionally, the resources needed for firefighting, such as water and chemical extinguishing agents, are constrained by availability thus necessitating substantial logistical support. This leads to longer fire incidents, increased property destruction, and greater risks to human safety.

### SUMMARY

The following summary is provided to facilitate an understanding of some of the innovative features unique to the present disclosure and is not intended to be a full description. A full appreciation of the present disclosure may be gained by taking the entire specification, claims, drawings, and abstract as a whole.

In various embodiments of the disclosure, a computer-implemented method for generation of a set of control instructions to acoustically extinguish a fire is described. The computer-implemented method includes receiving, by the computer, fire-bound area data associated with a fire within a fire-bound area. The fire-bound area data includes image data, environment data, geospatial data, and fire magnitude data. The computer-implemented method further includes applying, by the computer, an artificial intelligence (AI) model to the fire-bound area data. The computer-implemented method further includes determining, by the computer, requirement data to extinguish the fire. The requirement data is determined based on the application of the AI model to the fire-bound area data. The requirement data is indicative of a count associated with a set of aerial vehicles of a plurality of aerial vehicles and one or more operating parameters associated with each aerial vehicle of the set of aerial vehicles. The computer-implemented method further includes generating, by the computer, a set of control instructions based on the requirement data. The set of control instructions is associated with an operation of each aerial vehicle of the set of aerial vehicles for an acoustic extinguishing of the fire. The computer-implemented method further includes outputting, by the computer, the set of control instructions associated with each aerial vehicle of the set of aerial vehicles.

In various embodiments of the disclosure, a computer system for generation of set of control instructions to acoustically extinguish a fire is described.

In various embodiments of the disclosure, a computer program product for generation of set of control instructions to acoustically extinguish a fire is described. The computer program product includes a computer-readable storage medium having program instructions stored on the computer-readable storage media to perform operations. The operations include receiving fire-bound area data associated with a fire within a fire-bound area. The fire-bound area data comprises image data, environment data, geospatial data, and fire magnitude data. The operations further include applying an artificial intelligence (AI) model to the fire-bound area data. The operations further include determining requirement data to extinguish the fire. The requirement data is determined based on the application of the AI model to the fire-bound area data. The requirement data is indicative of a count associated with a set of aerial vehicles of a plurality of aerial vehicles and one or more operating parameters associated with each aerial vehicle of the set of aerial vehicles. The operations further include generating a set of control instructions based on the requirement data. The set of control instructions is associated with an operation of each aerial vehicle of the set of aerial vehicles for an acoustic extinguishing of the fire. The operations further include outputting the set of control instructions associated with each aerial vehicle of the set of aerial vehicles.

### BRIEF DESCRIPTION OF THE DRAWINGS

The following description will provide details of preferred embodiments with reference to the following figures wherein:

FIG. 1 is a diagram that illustrates a computing environment for generation of a set of control instructions associated with an operation of a set of aerial vehicles to extinguish a fire, in accordance with an embodiment of the disclosure;

FIG. 2 is a diagram that illustrates a network environment for the generation of the set of control instructions associated with the operation of the set of aerial vehicles to extinguish the fire, in accordance with an embodiment of the disclosure; and

FIG. 3 is a diagram that illustrates an exemplary environment for the generation of the set of control instructions associated with the operation of the set of aerial vehicles to extinguish the fire, in accordance with an embodiment of the disclosure;

FIG. 4A and FIG. 4B collectively illustrate one or more operations performed by the system for the generation of the set of control instructions associated with the set of aerial vehicles to extinguish the fire, in accordance with an embodiment of the disclosure;

FIG. 5 is a diagram that illustrates a flowchart for determination of requirement data to acoustically extinguish the fire, in accordance with an embodiment of the disclosure;

FIG. 6 is a diagram that illustrates a sequence diagram that depicts controlling of a control aerial vehicle to acoustically extinguish the fire, in accordance with an embodiment of the disclosure;

FIG. 7 is a diagram that illustrates a sequence diagram that depicts the controlling of aerial vehicles to acoustically extinguish the fire based on updated data associated with the fire, in accordance with an embodiment of the disclosure;

FIG. 8 is a diagram that illustrates a flowchart for training an artificial intelligence (AI) model based on training fire data, in accordance with an embodiment of the disclosure; and

FIG. 9 is a diagram that illustrates a flowchart of an exemplary method for the generation of the set control instructions associated with the set of aerial vehicles to extinguish the fire, in accordance with an embodiment of the disclosure.

### DETAILED DESCRIPTION

Vulnerability to fire has increased due to several factors, including, but not limited to, climate change, urbanization, and rising population density. Moreover, intensity and spread of forest fires have also increased substantially due to climate change, making the forest fires increasingly challenging to manage. In certain cases, fires may occur in hard-to-reach or remote areas, exacerbating the difficulty of containment efforts. Additionally, uncontrolled fires lead to increased pollution, adversely affect wildlife, and pose serious threats to the health and safety of nearby communities.

The fire management relies heavily on the knowledge and skills of firefighters. However, exposing firefighters to live fire situations presents numerous challenges, including, but not limited to, risks to the firefighter's safety, potential poisoning, and psychological stress. Current firefighting techniques typically depend on specific extinguishing agents, such as water, dry powder, or fog. It may be noted that not all extinguishing agents are suitable for every type of fire and the suitability of these extinguishing agents hinges on the materials involved in the combustion.

In some cases, firefighters may face limitations in identifying the appropriate extinguishing agents, particularly if the training of the firefighters has primarily focused on conventional structures. Furthermore, predicting the fire's behavior such as a direction and rate of spread of the fire remains difficult. Access to a diverse range of extinguishing agents is not always possible, and logistical challenges arise when transporting these materials to remote fire sites.

In particular, the present disclosure provides techniques for extinguishing fire through the use of acoustic waves. The system of the present disclosure utilizes the properties of sound waves to disrupt the combustion process and extinguish flames without the need for traditional extinguishing agents.

In particular, the present disclosure provides the system for automated fire management that utilizes acoustic waves for fire suppression. An acoustic wave for fire suppression refers to using low-frequency sound waves, typically in the range of 30-60 Hz, to extinguish flames by disrupting the combustion process by separating the oxygen from the fuel, effectively starving the fire and putting it out. These acoustic waves are generated by aerial vehicles, such as drones, which offer a flexible and efficient means of deployment. The system is configured to generate a set of control instructions for one or more aerial vehicles, directing to emit acoustic waves in a manner that extinguishes the fire.

Extinguishing the fire using the acoustic waves may prevent pollution and eliminate any environmental impact associated with the use of the conventional extinguishing agents. Moreover, extinguishing the fire using the acoustic waves may be faster as the acoustic waves directly target the combustion process without the need for physical extinguishing materials. Additionally, the deployment of aerial vehicles allows for rapid response in hard-to-reach areas, enhancing the overall efficiency of fire management efforts. The aerial vehicles are capable of reaching areas that are challenging or dangerous for human firefighters and traditional firefighting robots, thereby ensuring complete coverage of fire-affected zones. This may be beneficial in situations where direct human intervention is not feasible due to, for example, a remote location of the fire-affected zone, high intensity and area of the fire, and limited supply of extinguishing agents.

Acoustic waves may extinguish fires more efficiently than traditional methods such as water, foam, fog, or chemicals. This efficiency is attributed to the continuous generation of acoustic waves without the need for refueling, thus providing an environment-friendly firefighting solution. Furthermore, the ability of the system of the present disclosure to adapt in real-time to changing fire conditions ensures a more suitable response.

By integrating artificial intelligence (AI) models, the system performs predictive analysis and decision-making, thereby optimizing the deployment and operation of the one or more aerial vehicles. The one or more aerial vehicles deployed for extinguishing the fire may operate in a coordinated manner under the leadership of a control aerial vehicle, e.g., a leader aerial vehicle, to extinguish the fire. This coordinated effort enhances an overall efficiency of the firefighting process.

The system captures and analyses data from each firefighting operation to continuously improve the AI models for future incidents. With onboard edge computing capabilities, the one or more aerial vehicles may make quick decisions and adapt to fire conditions in real-time, enhancing the operational efficiency. The one or more aerial vehicles are equipped with acoustic jackets and protective measures to ensure that each of the one or more aerial vehicles operate safely in high-temperature environments. The use of the aerial vehicles for acoustic extinguishing of fire reduces the risk to human life by deploying aerial vehicles instead of human firefighters in dangerous situations.

The system of the present disclosure provides scalability and flexibility for scaling up or scaling down a number of the one or more aerial vehicles deployed in response to the specific needs of the fire. To this end, deploying an adequate number of aerial vehicles, such as by increasing the number of aerial vehicles or decreasing the number of aerial vehicles to combat or extinguish the fire is crucial. For example, the one or more aerial vehicles may need to be deployed based on a size and an intensity of the fire. Subsequently, the system allows for an increase or decrease in the number of aerial vehicles being deployed for extinguishing the fire during the fire-fighting process.

Beyond firefighting, the system of the present disclosure may be adapted for search-and-rescue operations and one or more emergency response scenarios. For instance, in search-and-rescue operations, aerial vehicles may be deployed to locate missing persons in difficult terrains, such as mountains, forests, or disaster-stricken areas. Equipped with advanced sensors and imaging technology, these vehicles can quickly cover large areas, providing real-time data to rescue teams on the ground.

Additionally, the system may be adapted for disaster response scenarios, such as floods, earthquakes, or hazardous material spills. The aerial vehicles may deliver required supplies, conduct aerial surveillance, and assess damage, facilitating a more coordinated and efficient emergency response. The ability to quickly reconfigure the system for different applications highlights the utility of the system in various high-stakes situations making it a valuable asset in emergency management and public safety efforts.

In various embodiments of the disclosure, a computer-implemented method for the generation of set of control instructions to acoustically extinguish a fire is described. The computer-implemented method includes receiving, by the computer, fire-bound area data associated with a fire within a fire-bound area. The fire-bound area data includes image data, environment data, geospatial data, and fire magnitude data. The computer-implemented method further includes applying, by the computer, an AI model to the fire-bound area data. The computer-implemented method further includes determining, by the computer, requirement data to extinguish the fire. The requirement data is determined based on the application of the AI model to the fire-bound area data. The requirement data is indicative of a count associated with a set of aerial vehicles of a plurality of aerial vehicles and one or more operating parameters associated with each aerial vehicle of the set of aerial vehicles. The computer-implemented method further includes generating, by the computer, a set of control instructions based on the requirement data. The set of control instructions is associated with an operation of each aerial vehicle of the set of aerial vehicles for an acoustic extinguishing of the fire. The computer-implemented method further includes outputting, by the computer, the set of control instructions associated with each aerial vehicle of the set of aerial vehicles.

In various embodiments of the disclosure, the computer-implemented method further includes controlling, by the computer, the operation of each aerial vehicle of the set of aerial vehicles. The operation of the set of aerial vehicles is controlled based on the set of control instructions. The computer-implemented method further includes generating, by the computer, an acoustic wave for the acoustic extinguishing of the fire. The acoustic wave is generated based on the controlling of the operation of each aerial vehicle of the set of aerial vehicles.

In various embodiments of the disclosure, the computer-implemented method further includes receiving, by the computer, location data associated with the fire within the fire-bound area. The computer-implemented method further includes generating, by the computer, control data for at least one aerial vehicle of the plurality of aerial vehicles. The control data is generated based on the location data. The computer-implemented method further includes controlling, by the computer, the at least one aerial vehicle based on the control data. The at least one aerial vehicle is controlled to collect the fire-bound area data.

In various embodiments of the disclosure, the at least one aerial vehicle of the plurality of aerial vehicles includes a plurality of sensors for collecting the fire-bound area data. The plurality of sensors includes at least one of thermal sensor, gyroscope, image sensor, or anemometer.

In various embodiments of the disclosure, the computer-implemented method further includes obtaining, by the computer, aerial vehicle data associated with each aerial vehicle of the plurality of aerial vehicles. The aerial vehicle data includes one or more operating characteristics of each aerial vehicle of the plurality of aerial vehicles. The computer-implemented method further includes applying, by the computer, the AI model to the aerial vehicle data. The computer-implemented method further includes determining, by the computer, the requirement data based on the application of the AI model to the aerial vehicle data.

In various embodiments of the disclosure, the one or more operating parameters associated with each aerial vehicle of the set of aerial vehicles include at least one of a geographical location for a deployment of each aerial vehicle of the set of aerial vehicles, or an acoustic frequency for the operation of each aerial vehicle of the set of aerial vehicles.

In various embodiments of the disclosure, the computer-implemented method further includes identifying, by the computer, a control aerial vehicle from the set of aerial vehicles. Each aerial vehicle of the set of aerial vehicles selects the control aerial vehicle. The computer-implemented method further includes receiving, by the computer, operation data associated with the operation of each aerial vehicle of the set of aerial vehicles. The operation data is received from the control aerial vehicle. The computer-implemented method further includes applying, by the computer, the AI model to the operation data. The computer-implemented method further includes updating, by the computer, the requirement data based on the application of the AI model to the operation data. The computer-implemented method further includes updating, by the computer, the set of control instructions based on the updated requirement data. The computer-implemented method further includes transmitting, by the computer, the updated set of control instructions to the control aerial vehicle.

In various embodiments of the disclosure, the computer-implemented method further includes controlling, by the computer, the control aerial vehicle based on the updated set of control instructions. The control aerial vehicle is controlled to transmit at least a part of the updated set of control instructions to each aerial vehicle of the set of aerial vehicles.

In various embodiments of the disclosure, the computer-implemented method further includes receiving, by the computer, update data associated with the fire within the fire-bound area. The update data is received from at least one of the set of aerial vehicles or the control aerial vehicle. The computer-implemented method further includes applying, by the computer, the AI model to the update data. The computer-implemented method further includes updating, by the computer, the set of control instructions based on the application of the AI model to the update data.

In various embodiments of the disclosure, the computer-implemented method further includes obtaining, by the computer, training fire data associated with each training fire event of a plurality of training fire events. The training fire data includes training intensity data, historical location data, historical environment data, historical extinguishing acoustic wave data, and historical deployment data. The computer-implemented method further includes training, by the computer, the AI model based on the training fire data.

In various embodiments of the disclosure, the environment data includes at least one of temperature data, wind speed data, wind direction data, or humidity data.

In various embodiments of the disclosure, a computer system for generation of a set of control instructions to acoustically extinguish a fire is described. The computer system includes a processor set, one or more computer-readable storage media, and program instructions stored on the one or more computer-readable storage media, the program instructions executable by the processor set to cause the processor set to receive fire-bound area data associated with a fire within a fire-bound area. The fire-bound area data includes image data, environment data, geospatial data, and fire magnitude data. Further, the program instructions cause the processor set to apply an AI model to the fire-bound area data. Further, the program instructions cause the processor set to determine requirement data to extinguish the fire. The requirement data is determined based on the application of the AI model to the fire-bound area data. The requirement data is indicative of a count associated with a set of aerial vehicles of a plurality of aerial vehicles and one or more operating parameters associated with each aerial vehicle of the set of aerial vehicles. Further, the program instructions cause the processor set to generate a set of control instructions based on the requirement data. The set of control instructions is associated with an operation of each aerial vehicle of the set of aerial vehicles for an acoustic extinguishing of the fire. Further, the program instructions cause the processor set to output the set of control instructions associated with each aerial vehicle of the set of aerial vehicles.

In various embodiments of the disclosure, the program instructions further cause the processor set to control the operation of each aerial vehicle of the set of aerial vehicles. The operation of the set of aerial vehicles is controlled based on the set of control instructions. Further, the program instructions cause the processor set to generate an acoustic wave for the acoustic extinguishing of the fire. The acoustic wave is generated based on the controlling of the operation of each aerial vehicle of the set of aerial vehicles.

In various embodiments of the disclosure, the program instructions further cause the processor set to receive location data associated with the fire within the fire-bound area. Further, the program instructions cause the processor set to generate control data for at least one aerial vehicle of the plurality of aerial vehicles. The control data is generated based on the location data. Further, the program instructions cause the processor set to control the at least one aerial vehicle based on the control data. The at least one aerial vehicle is controlled to collect the fire-bound area data.

In various embodiments of the disclosure, the program instructions further cause the processor set to obtain aerial vehicle data associated with each aerial vehicle of the plurality of aerial vehicles. The aerial vehicle data includes one or more operating characteristics of each aerial vehicle of the plurality of aerial vehicles. Further, the program instructions cause the processor set to apply the AI model to the aerial vehicle data. Further, the program instructions cause the processor set to determine the requirement data based on the application of the AI model to the aerial vehicle data.

In various embodiments of the disclosure, the program instructions further cause the processor set to identify a control aerial vehicle from the set of the set of aerial vehicles. Each aerial vehicle of the set of aerial vehicles selects the control aerial vehicle from the set of aerial vehicles. The program instructions further cause the processor set to receive operation data associated with the operation of each aerial vehicle of the set of aerial vehicles. The operation data is received from the control aerial vehicle. The program instructions further cause the processor set to apply the AI model to the operation data. The program instructions further cause the processor set to update the requirement data based on the application of the AI model to the operation data. The program instructions further cause the processor set to update the set of control instructions based on the updated requirement data. The program instructions further cause the processor set to transmit the updated set of control instructions to the control aerial vehicle.

In various embodiments of the disclosure, the program instructions further cause the processor set to control the control aerial vehicle based on the updated set of control instructions. The control aerial vehicle is controlled to transmit at least a part of the updated set of control instructions to each aerial vehicle of the set of aerial vehicles.

In various embodiments of the disclosure, the program instructions further cause the processor set to receive update data associated with the fire within the fire-bound area. The update data is received from at least one of the set of aerial vehicles or the control aerial vehicle. The program instructions further cause the processor set to apply the AI model to the update data. The program instructions further cause the processor set to update the set of control instructions based on the application of the AI model to the update data.

In various embodiments of the disclosure, the program instructions further cause the processor set to obtain training fire data associated with each training fire event of a plurality of training fire events. The training fire data comprises training intensity data, historical location data, historical environment data, historical extinguishing acoustic wave data, and historical deployment data. The program instructions further cause the processor set to train the AI model based on the training fire data.

In various embodiments of the disclosure, a computer program product for generation of a set of control instructions to acoustically extinguish a fire is described. The computer program product includes one or more computer-readable storage media. The computer program product includes program instructions stored on the one or more computer-readable storage media to perform operations includes receiving fire-bound area data associated with a fire within a fire-bound area. The fire-bound area data comprises image data, environment data, geospatial data, and fire magnitude data. The operations further include applying an AI model to the fire-bound area data. The operations further include determining requirement data to extinguish the fire. The requirement data is determined based on the application of the AI model to the fire-bound area data. The requirement data is indicative of a count associated with a set of aerial vehicles of a plurality of aerial vehicles and one or more operating parameters associated with each aerial vehicle of the set of aerial vehicles. The operations further include generating a set of control instructions based on the requirement data 204B. The set of control instructions is associated with an operation of each aerial vehicle of the set of aerial vehicles for an acoustic extinguishing of the fire. The operations further include outputting the set of control instructions associated with each aerial vehicle of the set of aerial vehicles.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations may be performed in a different order than what is shown in each flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that may retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or freely propagating electromagnetic waves, electromagnetic waves propagating through a waveguide, light pulses passing through a fiber optic cable, electrical signals communicated through a wire, and/or transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

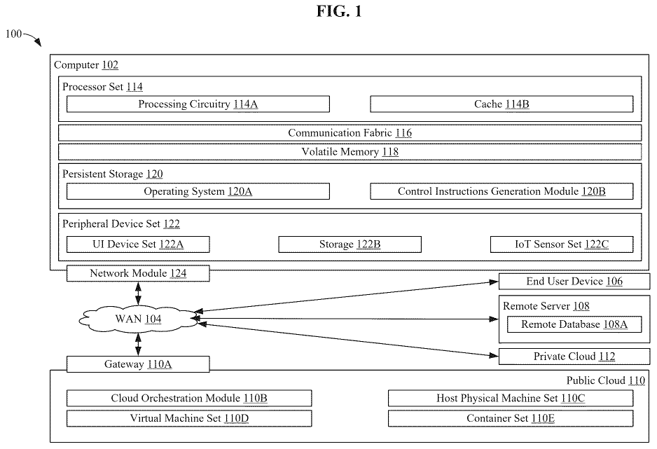

FIG. 1 is a diagram that illustrates a computing environment for the generation of a set of control instructions associated with an operation of a set of aerial vehicles to extinguish the fire, in accordance with an embodiment of the disclosure. With reference to FIG. 1, there is shown a computing environment 100 that contains an example of an environment for the execution of at least some of the computer code involved in performing the disclosed methods, such as a control instructions generation module 120B. In addition to the control instructions generation module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the control instructions generation module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or wearable computer, a mainframe computer, a quantum computer, or any form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. In an embodiment, in this presentation of the computing environment 100, detailed discussion is focused on a single computer, specifically the computer 102, to keep the presentation as simple as possible. The computer 102 may be located in a cloud, even though it is not shown in a cloud in FIG. 1. The computer 102 is not required to be in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby affect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the storage media discussed below. The program instructions, and associated data, are accessed by the processor set 114 to control and direct the performance of the disclosed methods. In computing environment 100, at least some of the instructions for performing the disclosed methods may be stored in the dynamic modification of the control instructions generation module 120B in persistent storage 120.

Communication fabric 116 is the signal conduction path that allows the various components of computer 102 to interact and exchange information. Typically, this fabric is made of switches and electrically conductive paths, such as the switches and electrically conductive paths that make up buses, bridges, physical input/output ports, and the like. Types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to the computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the control instructions generation module 120B typically includes at least some of the computer code involved in performing the disclosed methods.

The peripheral device set 122 includes the set of peripheral devices of computer 102. Data communication connections between the peripheral devices and the components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that may be used in Internet of Things applications. For example, a first sensor may be a thermometer, and a second sensor may be a motion detector.

The network module 124 is the collection of computer software, hardware, and firmware that allows computer 102 to communicate with the computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods may typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 may display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or the computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs may be stored as “images”. A new active instance of the VCE may be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system may utilize all resources of that computer, such as connected devices, files and folders, network shares, CPU power, and quantifiable hardware capabilities. However, programs running inside a container may only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

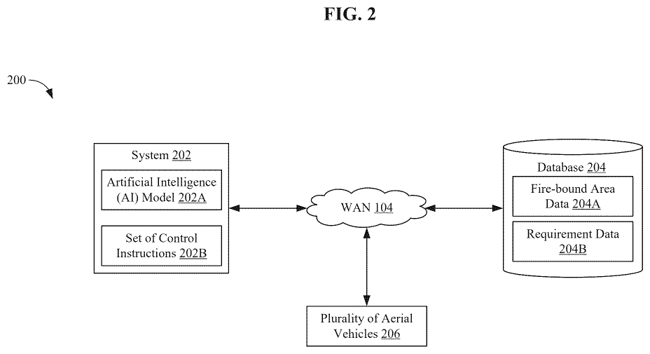

FIG. 2 is a diagram that illustrates a network environment for the generation of a set of control instructions 202B associated with the operation of the set of aerial vehicles to extinguish the fire, in accordance with an embodiment of the disclosure. FIG. 2 is explained in conjunction with elements from FIG. 1. With reference to FIG. 2, there is shown a diagram of a network environment 200. The network environment 200 includes a system 202 (also referred to as a computer system). The system 202 includes an Artificial Intelligence (AI) model 202A and a set of control instructions 202B. The network environment 200 further includes a database 204. The database 204 further includes fire-bound area data 204A and requirement data 204B. The network environment 200 further includes a plurality of aerial vehicles 206. The network environment 200 further includes the WAN 104 of FIG. 1. In an example, the system 202 is an exemplary embodiment of the computer 102 in FIG. 1.

The system 202 may include suitable logic, circuitry, interfaces, and/or code that may be configured to receive the fire-bound area data 204A associated with a fire within a fire-bound area. The fire-bound area data 204A includes image data, environment data, geospatial data, and fire magnitude data. The system 202 is further configured to apply an AI model 202A to the fire-bound area data 204A. The system 202 is further configured to determine the requirement data 204B to acoustically extinguish the fire. The requirement data 204B is determined based on the application of the AI model 202A to the fire-bound area data 204A. The requirement data 204B is indicative of a count associated with a set of aerial vehicles of a plurality of aerial vehicles 206 and one or more operating parameters associated with each aerial vehicle of the set of aerial vehicles. The system 202 is further configured to generate a set of control instructions 202B based on the requirement data 204B. The set of control instructions 202B is associated with an operation of each aerial vehicle of the set of aerial vehicles to acoustically extinguish the fire. The system 202 is further configured to output the set of control instructions 202B associated with each aerial vehicle of the set of aerial vehicles.

In an embodiment, the AI model 202A is configured to perform tasks, such as, but not limited to, recognizing patterns, making decisions, and predicting outcomes. The AI model 202A analyzes complex datasets, making particularly valuable in applications like fire management. The AI model 202A learns from a wide array of examples, continuously improving performance over time. The AI model 202A analyzes data from fire-affected areas, referred to as the fire-bound area data 204A. This data includes satellite imagery and aerial photographs, providing insights into the extent and behavior of fire within the fire-bound area. By leveraging advanced image processing techniques, the AI model 202A identifies patterns and anomalies which is needed for decision-making in emergencies.

Further, the AI model 202A employs various techniques for processing image data, including, but not limited to, Convolutional Neural Networks (CNN), data augmentation, image classification, object detection, semantic segmentation, and image enhancement. These techniques enable the AI model 202A to categorize elements within the fire-bound area data 204A, identify specific objects like flames and smoke, enable automated suppression of fire, enhance situational awareness, and implement and support the firefighting strategies.

In an embodiment, the database 204 is a structured collection of data that enables efficient storage, retrieval, and management of information, often organized in a way that facilitates easy access and manipulation. Typically stored electronically in the system 202, the databases are structured to facilitate quick access and manipulation of data through a Database Management System (DBMS). In an embodiment, the system 202 may utilize the database 204 to store and manage data associated with the operation and performance of the plurality of aerial vehicles 206. By way of example, and not by limitation, the database 204 includes a repository that integrates various types of information needed for fire management and acoustic extinguishing operations. The database 204 is configured to store the fire-bound area data 204A, and requirement data 204B. The fire-bound area data 204A provides real-time insights into the specific area affected by a fire. The fire-bound area data 204A aids in understanding the fire's behavior and potential spread. The requirement data 204B includes a count of the number of aerial vehicles needed for extinguishing the fire within the fire-bound area, the operational parameters associated with the aerial vehicles, and specific instructions for each vehicle to ensure a suitable response. The database 204 is specifically configured to store historical data and operational parameters related to firefighting operations involving the set of aerial vehicles 206. The database 204 stores past incidents of fire suppression efforts, including details about the types of fires encountered, and the methods used for extinguishing the fire. This historical data helps in training the AI model 202A to predict outcomes in future firefighting scenarios. The database 204 contains real-time operational metrics collected from the set of aerial vehicles of the plurality of aerial vehicles 206 during missions. This includes data on environmental conditions such as temperature, humidity, wind speed, and direction at various locations. In an embodiment, the database 204 stores information regarding the performance of individual aerial vehicles, including the operational capabilities, battery life, acoustic wave output capacities, and any maintenance records.

In an embodiment, an aerial vehicle of the plurality of the aerial vehicles 206 represents a vehicle designed to fly in the air medium and for various applications, such as, but not limited to, surveillance, transportation, and delivery. The aerial vehicle may be operated with or without a human pilot on board, utilizing technologies for navigation and control. The design of the aerial vehicle may incorporate aerodynamic features such as wings, rotors, control surfaces, and propulsion system which enable the aerial vehicle to achieve lift and stability. The propulsion system may correspond to but is not limited to, electric, gasoline-powered, or hybrid, which provides adequate thrust for flight. The aerial vehicles may include sensors, instruments, Global Positioning System (GPS) for accurate positioning, cameras for visual surveillance, infrared sensors for thermal imaging, and Light Detection and Ranging (LIDAR) for mapping and obstacle detection. A control system of the aerial vehicle may be autonomous, relying on pre-programmed flight paths and real-time data processing, or the aerial vehicle may be remotely piloted by a human operator using a ground station.

In an embodiment, the fire-bound area represents a geographical region where a fire incident or a combustion incident is occurring or ongoing. The fire-bound area is characterized by certain features that differentiate the fire-bound area from surrounding areas, such as, but not limited to, the presence of flames, smoke, heat, and potentially charred or burning materials. The fire-bound area may correspond to a defined spatial extent on the Earth's surface, encompassing areas affected by the fire. The fire-bound area exhibits relative homogeneity in terms of fire-related characteristics, which may include natural elements like burning vegetation, trees, and underbrush, as well as human-made structures such as buildings, vehicles, and infrastructure that are on fire. The boundaries of the fire-bound area may be clearly defined, such as, but not limited to, by firebreaks, roads, or natural barriers like rivers and cliffs, or the boundaries of the fire-bound area may be transitional, where the intensity of the fire gradually decreases and blends into less affected areas within the fire-bound area. The fire-bound area may be identified by environmental impact due to fire, including changes in air quality, temperature, and visibility, as well as potential threats to human safety, wildlife, and property. The fire-bound area may be monitored and managed by firefighting efforts, which aim to contain and extinguish the fire, mitigate damage, and protect surrounding regions.

In operation, the system 202 is configured to receive fire-bound area data 204A associated with the fire within the fire-bound area. In an embodiment, the system 202 receives the fire-bound area data 204A associated with the fire within the fire-bound area using satellite imagery. Satellites equipped with thermal imaging sensors detect heat signatures from the fire in the fire-bound area. In an example, the satellites provide high-resolution visuals, and thermal cameras capture heat signatures of the fire. In an embodiment, drones or Unmanned Aerial Vehicles (UAVs) equipped with cameras and thermal sensors may be deployed to capture the fire-bound area data 204A from above the fire-bound area. The fire-bound area data 204A may also include real-time data from the aerial vehicles, which capture geospatial information and provide multi-spectral images that identify critical hot spots, intensity, and obstacles within the fire-bound area. In an example, the fire-bound area data 204A is received from ground-based sensors. The ground-based sensors detect temperature changes, smoke, and indicators of fire within the fire-bound area. By way of example, and not limitation, the fire-bound area data 204A may be received from weather stations that are equipped with fire detection capabilities that may monitor environmental conditions such as temperature, humidity, and wind speed, which are critical for predicting fire spread in the fire-bound area. In an example, the fire-bound area data 204A is received from mobile applications used by firefighters and first responders. The mobile application allows users to report fire boundaries.

In an example, the fire-bound area data 204A includes image data, environment data, geospatial data, and fire magnitude data. In an embodiment, the image data includes visual or spectral representations of the fire-bound area, obtained through various mediums such as, but not limited to, satellite observation, aerial photography, or imaging techniques. The image data includes specific wavelengths of light pattern associated with the fire-bound area, helping to identify heat signatures and the presence of smoke or flames in the fire-bond area. Further, the environmental data includes information about the geographical and atmospheric conditions of the fire-bound area, such as, but not limited to, terrain, vegetation, weather patterns, wind direction, wind speed, and air quality. Further, the geospatial data includes spatial characteristics and location-based information on the fire-bound area. The geospatial data includes geographical coordinates, maps, and spatial relationships between different features within the fire-bound area. The fire magnitude data includes details about the intensity and spread of the fire, including metrics like temperature, flame height, rate of spread, and affected area size. The fire magnitude data includes the energy and the potential of the fire to spread to new areas near the fire-bound area.

Further, the system 202 is configured to apply the AI model 202A to the fire-bound area data 204A. Upon receiving the fire-bound area data 204A, the AI model 202A utilizes advanced analysis and decision-making capabilities on the fire-bound area data 204A, which includes the image data, the environmental data, the geospatial data, and the fire magnitude data. The system preprocesses the fire-bound area data 204A to ensure compatibility with the AI model 202A. In an example, the preprocessing includes normalizing data formats, filtering out noise from image data, and extracting relevant features that the AI model 202A may utilize. The AI model 202A is trained on vast datasets, enabling the AI model 202A to recognize patterns and make predictions based on historical fire behavior and environmental factors. When applied to the fire-bound area data 204A, the AI model 202A analyses various input parameters to assess the current fire situation in the fire-bound area. For instance, the AI model 202A may evaluate the relationship between weather conditions and fire spread, identify areas at high risk of ignition, and predict potential fire behavior based on topographical features and vegetation types. Additionally, the AI model 202A enhances image data interpretation through computer vision techniques, allowing for the automated detection of fire hotspots and the assessment of fire intensity from the fire-bound area data 204A. This may enable real-time monitoring of the fire. The AI model 202A utilizes machine learning models to process the fire-bound area data 204A to understand the characteristics of the fire, which enables precise decision-making for fire management and suppression efforts. The AI model 202A is trained on extensive datasets to recognize patterns and make accurate predictions. The AI model 202A processes various types of data, including visual and spectral representations, geographical and atmospheric conditions, and fire intensity metrics.

Further, the system 202 is configured to determine the requirement data 204B to acoustically extinguish the fire within the fire-bound area. The requirement data 204B is determined based on the application of the AI model 202A to the fire-bound area data 204A. The requirement data 204B is indicative of a count associated with a set of aerial vehicles of a plurality of aerial vehicles 206 and one or more operating parameters associated with each aerial vehicle of the set of aerial vehicles. In an embodiment, the system 202 is configured to support fire extinguishing efforts by generating the requirement data 204B for acoustically extinguishing the fire within the fire-bound area in an automated manner using aerial vehicles. This capability is particularly relevant in scenarios where traditional firefighting methods may be less suitable due to, such as remote locations, large areas of fire, and the like.

The system 202 is configured to determine the requirement data 204B based on the application of the AI model 202A to the fire-bound area data 204A. The requirement data 204B includes information associated with, for example, fire intensity, environmental conditions, geospatial characteristics, and historical fire behavior. The AI model 202A processes the fire-bound area data 204A to assess the current fire situation, predict the potential spread, and identify suitable strategies for containment and extinguishment of the fire. The requirement area 204b includes a count of aerial vehicles to be deployed for extinguishing the fire based on a detailed analysis of the fire and predicted fire characteristics. The requirement data 204B is indicative of two primary components: the count associated with a set of aerial vehicles and operating parameters for each aerial vehicle of the set of aerial vehicles. In an example, the operational parameters may include, but is not limited to, the location or position of deployment of each aerial vehicle, flight altitude for each aerial vehicle, speed of each aerial vehicle, and frequency parameters for generating an acoustic wave for fire suppression for each aerial vehicle. The AI model 202A may also consider factors such as wind direction and speed to optimize the requirement data, ensuring that the acoustic wave produced by the set of aerial vehicles disrupts the combustion process and extinguishes the fire within the fire-bound area. By way of example, and not by limitation, the AI model 202A evaluates the size of the fire, the intensity of the fire, and the surrounding environmental conditions associated with the fire-bound area to determine the count of aerial vehicles needed for extinguishing the fire. Accurate determination of the count of aerial vehicles and corresponding operating parameters may enable prompt fire suppression, reduce resource wastage, and reduce logistical challenges.

Further, the system 202 is configured to generate a set of control instructions 202B based on the requirement data 204B. The set of control instructions 202B is associated with an operation of each aerial vehicle of the set of aerial vehicles to acoustically extinguish the fire within the fire-bound area. In an embodiment, the system 202 is configured to generate the set of control instructions 202B based on the requirement data 204B. The set of control instructions 202B may be used to control the operations of each aerial vehicle within the set of aerial vehicles tasked with acoustically extinguishing the fire within the fire-bound area. Upon receiving the requirement data 204B, the system 202 generates the set of control instructions 202B. The set of control instructions 202B may ensure that each aerial vehicle of the set of aerial vehicles operates in a coordinated manner for extinguishing the fire within the fire-bound area. By way of example, and not by limitation, the set of control instructions includes specific operational parameters for each aerial vehicle of the set of aerial vehicles, such as flight altitude, speed, and maneuvering patterns.

For instance, a control instruction of the set of control instructions 202B may dictate that an aerial vehicle of the set of aerial vehicles flies at a lower altitude to optimize the acoustic waves'impact on the fire while few aerial vehicles of the set of aerial vehicles maintain a higher altitude for broader coverage. Further, the set of control instructions includes specifying an acoustic emission setting for each aerial vehicle of the set of aerial vehicles. This includes the frequency and intensity of the acoustic waves to be generated. The system 202 instructs vehicles to utilize varying frequencies based on the fire's characteristics, as different frequencies have distinct effects on combustion processes. Further, the set of control instructions also defines the flight paths for each aerial vehicle of the set of aerial vehicles for the operation of the set of aerial vehicles. Moreover, the operation of the set of aerial vehicles may be coordinated to prevent overlap or gaps in coverage, allowing for effective acoustic intervention.

The system 202 utilizes the AI model 202A to determine the flight routes that account for wind patterns, the fire spread predictions, and the locations of each aerial vehicle of the set of aerial vehicles relative to the fire. By generating a well-defined set of control instructions 202B, system 202 enhances the efficiency of the operation of the set of aerial vehicles in combating the fire within the fire-bound area. This use of the acoustic waves and aerial vehicles may provide a significant advancement in firefighting capabilities, improving outcomes and safety for both responders and communities at risk.

Further, the system 202 is configured to output the set of control instructions 202B associated with each aerial vehicle of the set of aerial vehicles. In an embodiment, the system 202 outputs the set of control instructions 202B. In an embodiment, the system 202 is configured to output the set of control instructions 202B associated with each aerial vehicle within the set of aerial vehicles tasked with acoustic extinguishing fire within the fire-bound area. The output of the set of control instructions 202B is a critical step in the operational workflow, ensuring that each aerial vehicle of the set of aerial vehicles is equipped with adequate directives to execute mission. The system 202 transmits this information to each aerial vehicle of the set of aerial vehicles in real-time. The output includes specific operational parameters tailored to each vehicle's capabilities and the unique conditions of the fire-bound area. These parameters may include, for example, flight altitude, speed, and the precise acoustic settings for the fire suppression.

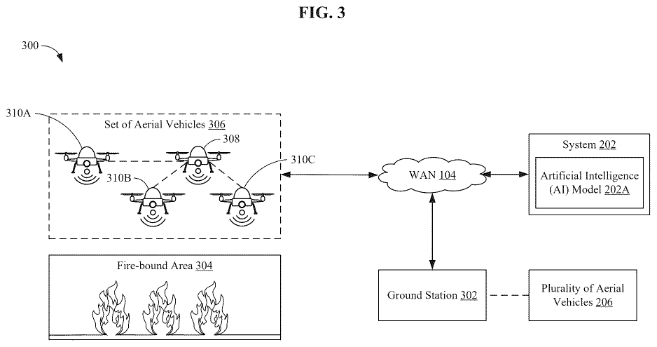

FIG. 3 is a diagram that illustrates an exemplary environment for the generation of the set of control instructions 202B associated with the operation of the set of aerial vehicles 306 to extinguish the fire, in accordance with an embodiment of the disclosure. FIG. 3 is explained in conjunction with elements from FIG. 1 and FIG. 2. With reference to FIG. 3, there is shown a diagram of a network environment 300. The network environment 300 includes the set of aerial vehicles 306, and a ground station 302. The set of aerial vehicles 306 includes a control aerial vehicle 308, a first aerial vehicle 310A, a second aerial vehicle 310B, and a third aerial vehicle 310C.

In an embodiment, the fire-bound area 304 represents a specific geographical region having the presence of fire, whether due to natural causes, human activities, or a combination of both. The fire-bound area 304 may encompass a variety of landscapes, including dense forests, grasslands, urban environments, or a combination. By way of example, and not by limitation, in the case of forest fires, the fire-bound area 304 typically includes vast stretches of woodland, characterized by a dense canopy of trees, underbrush, and a variety of vegetation types. These natural features create a relatively homogenous environment where the availability of dry fuel, coupled with specific weather conditions such as high temperatures and strong winds, leads to rapid fire spread. The geographical region of a forest fire includes topographical elements such as valleys, ridges, and slopes, which significantly affect fire behavior. For instance, the fires tend to move faster uphill due to the rising heat, while valleys may trap smoke and heat, creating dangerous conditions for both firefighters and nearby communities. In an embodiment, the fire-bound areas 304 in urban settings may include buildings, infrastructure, and other human-made features. These areas are often characterized by a higher density of combustible materials, such as wood, plastics, and other flammable substances found in construction materials and furnishings. The proximity of structures may create a unique set of challenges for firefighting efforts, as fires spread rapidly between buildings, especially in densely populated areas. Moreover, the presence of utilities, such as gas lines and electrical systems, poses additional hazards during fire incidents. In an embodiment, the boundaries of the fire-bound area 304 may defined by the specific features that contribute to the fire risk. In natural environments, the boundaries of the fire-bound area 304 may be delineated by changes in vegetation types, elevation, or the presence of natural barriers like rivers or rocky outcrops. In urban areas, boundaries of the fire-bound area 304 may align with streets, property lines, or zoning regulations.

In an embodiment, the ground station 302 serves as the operational hub for managing the plurality of aerial vehicles 206 deployed for fire extinguishing missions. Strategically located to facilitate quick access to the fire-bound area 304, the ground station 302 is equipped with advanced communication and control systems that enable seamless coordination of aerial operations. Each aerial vehicle of the plurality of aerial vehicles 206 is stationed here when not in use, allowing for efficient maintenance, recharging, and preparation for upcoming missions.

By way of example, and not by limitation, when a fire incident is detected in the fire-bound area 304, the ground station 302 activates response protocols. Utilizing data from the database 204, the ground station 302 assesses the fire's characteristics and the environmental conditions of the affected area. Based on this analysis, a set of aerial vehicles 306 is dispatched to the fire-bound area 304. The set of aerial vehicles 306 are deployed for the operation based on the set of control instructions 202B generated by the system 202. The set of control instructions 202B may be used to control flight paths, acoustic emission settings, and other operational parameters of each of the set of aerial vehicles 306. As the set of aerial vehicles 306 engages in the operation of extinguishing the fire, the system 202 and the ground station 302 maintain real-time communication with a control aerial vehicle 308 for monitoring a progress of the set of aerial vehicles 306 and providing support as needed. Once the fire within the fire-bound area 304 is extinguished, each aerial vehicle of the set of aerial vehicles returns to the ground station 302, where each aerial vehicle of the set of aerial vehicles undergo post-mission assessments. The post mission assessments include determining any repairs, reloading supplies, and analyzing mission data for future improvements. The ground station 302 not only serves as a base for the plurality of aerial vehicles 206 but also acts as a central command center for coordinating firefighting efforts. By efficiently managing the deployment and return of each aerial vehicle of the set of aerial vehicles 306, the ground station 302 ensures rapid responses to fire incidents, thereby enhancing overall fire management strategies and community safety.

In an embodiment, the set of aerial vehicles 306 includes a control aerial vehicle 308 and one or more aerial vehicles for extinguishing fires within the fire-bound area 304. The control aerial vehicle 308 establishes a connection with each aerial vehicle in the set of aerial vehicles 306, ensuring communication and coordination during firefighting operations. In an embodiment, the set of the aerial vehicle 306 comprises the control aerial vehicle 308, along with three aerial vehicles, namely, a first aerial vehicle 310A, a second aerial vehicle 310B, and a third aerial vehicle 310C (collectively referred to as aerial vehicles 310). The control aerial vehicle 308 is interconnected with each of the three aerial vehicles, enabling seamless communication and coordination during firefighting operations. Further, the control aerial vehicle 308 receives the set of control instructions 202B from the system 202. Further, the control aerial vehicle 308 transmits at least a part of the set of control instructions to guide the aerial vehicles 310 in executing the operations and ensuring that the set of the aerial vehicle 306 operates in a synchronized manner to combat fires in the fire-bound area 304.

Additionally, the control aerial vehicle 308 is configured to receive real-time feedback from the aerial vehicles 310. This feedback is needed for adjusting a strategy for firefighting based on the evolving conditions of the fire and the fire-bound area 304. By continuously receiving real-time feedback from the aerial vehicles 310, the control aerial vehicle 308 makes informed decisions.

In an embodiment, the system 202 may be implemented on the control aerial vehicle 308 and is further integrated with the system 202. This integration enables the control aerial vehicle 308 to update the set of control instructions 202B for the aerial vehicles 310 within the fleet for extinguishing the fire.

In certain scenarios, multiple control vehicles may be deployed. In such a case, each aerial vehicle of the set of aerial vehicles 306 may be configured to communicate with the set of aerial vehicles 306 in the respective sets. This redundancy ensures that operations may continue smoothly, even if one control vehicle encounters issues. The ability of the control vehicle to manage multiple aerial units simultaneously is beneficial for large-scale firefighting efforts, particularly in the fire-bound area 304.

Additionally, the control aerial vehicle 308 may incorporate an advanced artificial intelligence (AI) model designed to enhance operational decision-making during firefighting missions. This AI model 202A may analyze real-time data regarding the fire's behavior and environmental conditions. By leveraging machine learning algorithms, the AI model 202A may adapt strategies based on ongoing assessments, optimizing the deployment of the aerial vehicles 310 and resources to achieve the fire extinguishment.

The integration of the AI model 202A into the control aerial vehicle 308 improves the efficiency of fire extinguishing operations and also enhances the safety of the set of aerial vehicles 306. By processing vast amounts of data quickly, the AI model 202A may predict fire spread patterns, and fire characteristics and adjust the operation of the set of aerial vehicles 306 on-the-fly, ensuring that the set of aerial vehicles 306 is operating under the most suitable parameters.

Furthermore, the communication network established between the control aerial vehicle 308 and the set of aerial vehicles 306 allows for real-time feedback and adjustments. In an example, if conditions associated with the fire-bound area 304 change such as, but not limited to, shifts in wind direction or unexpected flare-ups the control aerial vehicle 308 may immediately generate or cause the system 202 to generate an updated set of instructions for the set of aerial vehicles 306 to ensure that firefighting efforts remain focused and suitable.

In an embodiment, the set of aerial vehicles 306 includes a control aerial vehicle 308 and one or more aerial vehicles for extinguishing the fire in the fire-bound area 304. In an example, the control aerial vehicle 308 is connected to each aerial vehicles in the set of aerial vehicles 306. Further, the control aerial vehicle is connected to the system 202 and the ground station 302. In an example, the system 202 is implemented on the control aerial vehicle 308. Further, the control aerial vehicle 308 is configured to generate the set of control instructions 202B to each aerial vehicle of the set of aerial vehicles 306. In an embodiment, the set of aerial vehicles includes one or more control aerial vehicles similar to the behavior of the control aerial vehicle 308. The one or more control vehicles are configured to communicate with each aerial vehicles of the set of aerial vehicles 306. In an embodiment, each control aerial vehicle of the one or more control aerial vehicles may include the AI model 202A to perform the operation for extinguishing the fire in the fire-bound area 304.

By way of example, and not by limitation, each of the plurality of aerial vehicles 206 may include at least one of thermal sensors, gyroscope, image sensor, anemometer, or acoustic transducers. In an example, at least one of the plurality of aerial vehicles 206 is configured to collect the fire-bound area data 204A and transmit the fire-bound area data 204A to the system 202. In an example, the thermal sensors are configured to detect heat signatures, allowing for the identification of hotspots and the fire-bound area 304, while the image sensors capture visual data that aids in assessing the extent of damage and monitoring fire behavior within the fire-bound area 304. The gyroscopes provide stability and orientation data, ensuring accurate positioning of the at least one aerial vehicle during data collection as well as flight. Further, the anemometers measure wind speed and direction, which influence fire spread and behavior. The acoustic transducers transmit sound frequencies to extinguish the fire within the fire-bound area 304.

In an embodiment, if the battery of an aerial vehicle is low during the operation, the ground station 302 may send an alternate aerial vehicle for the operation. In an example, if the battery of an aerial vehicle from the set of aerial vehicles 306 is low during operation, the ground station 302 is configured to dispatch an alternate aerial vehicle from the plurality of aerial vehicle 206. This ensures continuous data collection and operational efficiency for extinguishing the fire within the fire-bound area 304.

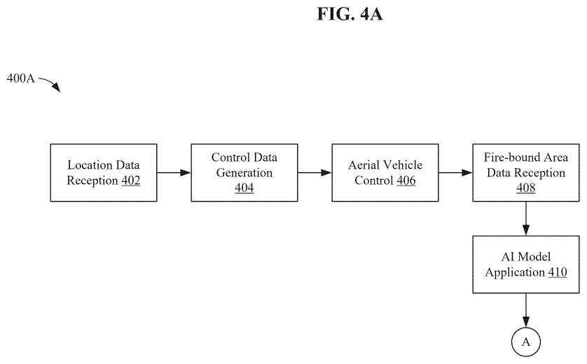

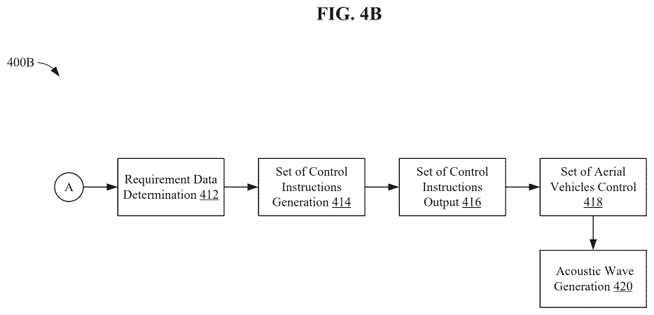

FIG. 4A and FIG. 4B illustrate a block diagram 400A and a block diagram 400B, respectively, of one or more operations performed by the system 202 for the generation of the set of control instructions 202B associated with the set of aerial vehicles 306 to extinguish the fire, in accordance with an embodiment of the disclosure.

Referring to FIG. 4A, the block diagram 400A for the generation of the set of control instructions 202B associated with the set of aerial vehicles 306 is illustrated. FIG. 4A is explained in conjunction with elements from FIG. 1, FIG. 2, and FIG. 3. With reference to FIG. 4A, the operations may start at 402.

At 402, a location data reception operation is executed. In the location data reception operation, the system 202 is configured to receive location data associated with the fire within the fire-bound area 304. By way of example, and not by limitation, the system 202 receives the location data from one or more sources, ensuring comprehensive and real-time data of the fire-bound area 304. The one or more sources include satellite imagery, ground-based sensors, aerial reconnaissance from drones or helicopters, and advanced monitoring technologies that provide critical information about the fire's geographical coordinates (e.g., geographical location of the fire-bound area 304). By leveraging one or more sources, the system 202 ensures greater accuracy and reliability in tracking the fire's progression within the fire-bound area 304 compared to the traditional method. Further, the location data typically includes geographical coordinates, such as latitude and longitude, which are instrumental in pinpointing the exact location of the fire-bound area 304.

At 404, a control data generation operation is executed. In the control data generation operation, the system 202 is configured to generate control data for at least one aerial vehicle of the plurality of aerial vehicles 206. The control data is generated based on the location data. By way of example, and not by limitation, the system 202 generates the control data for controlling an operation of at least one aerial vehicle of the plurality of aerial vehicles 206. The system 202 generates the control data using the AI model 202A based on the received location data associated with the fire within the fire-bound area 304. The control data includes instructions for the deployment of at least one aerial vehicle in the fire-bound area 304 for collecting the fire-bound area data 204A. Further, the control data includes geographical coordinate data (such as latitude and longitude), and safe height data for the at least one aerial vehicle in the vicinity of fire-bound area 304. Further, the control data includes flight path data or trajectory data for the at least one aerial vehicle to reach the fire-bound area 304. Further, the flight path data includes a path avoiding obstacles, speed data for the at least one aerial vehicle, and protocols for self-protection of the at least one aerial vehicle from obstacles or fire. Further, the control data includes instructions for the at least one aerial vehicle for data collection and instructions for data transmission. In an example, the at least one aerial vehicle from the plurality of aerial vehicles 206 is configured to detect environment data at the fire-bound area 304 such as wind speed, wind direction, smoke, temperature, humidity, visual data, spatial data (such as topographical information), and fire behavior data (such as flame height and flame spread direction). In an example, the at least one aerial vehicle is configured to detect and analyze the composition of smoke and identify hazardous gases, including, but not limited to, carbon monoxide and methane. The temperature sensors are configured to measure the temperature distribution within the fire-bound area 304. In an example, the at least one aerial vehicle may include Light Detection and Ranging (LIDAR) sensors to perform terrain mapping and generate a three-dimensional model of the fire-bound area 304.

At 406, an aerial vehicle control operation is executed. In the aerial vehicle control operation, the system 202 is configured to control the at least one aerial vehicle based on the control data. The at least one aerial vehicle of the plurality of aerial vehicles 206 is controlled to collect the fire-bound area data 204A. The controlling of the at least one aerial vehicle includes navigation control, mission execution control, safety protocols, communication, and energy management, either autonomously or through a pilot of the at least one aerial vehicle. The controlling of at least one aerial vehicle may include, but is not limited to, route planning and real-time adjustments to ensure the aerial vehicle reaches the fire-bound area 304 avoiding obstacles. The system 202 controls the flight paths, and altitude settings and adjusts dynamically based on environmental factors such as wind and smoke. The controlling of at least one aerial vehicle includes hovering over the fire-bound area 304 to gather the fire-bound area data 204A based on the control data. The at least one aerial vehicle receives the command from the ground station 302 or the system 202 through communication protocols to control cameras or sensors ensuring that the at least one aerial vehicle of the plurality of aerial vehicles 206 performs tasks such as data collection.

The at least one aerial vehicle is configured to collect and transmit the fire-bound area data 204A to the system 202 and/or the ground station 302. The data transmitted by the at least one aerial vehicle may include, for example, thermal images and/or sensor readings, and feedback mechanisms about the status of the at least one aerial vehicle, including, but not limited to, location, battery level, and mission progress associated with the aerial vehicle. In an embodiment, at least one aerial vehicle communicates with each other to distribute tasks, share data, avoid duplication, and enhance coordination and efficiency. In an example, the system 202 is configured to monitor the battery level associated with the at least one aerial vehicle to ensure sufficient power for mission completion or return-to-ground station 302 operations.

At 408, a fire-bound area data reception operation is executed. In the fire-bound area data reception operation, the system 202 is configured to receive the fire-bound area data 204A associated with the fire within the fire-bound area 304. The fire-bound area 304 data include, but is not limited to, the image data, the environment data, the geospatial data, and the fire magnitude data. By way of example, and not by limitation, the fire-bound area data 204A corresponds to information received from the fire-bound area 304. The fire-bound area data 204A is received from the at least one aerial vehicle of the plurality of aerial vehicle 206.

In an embodiment, the fire-bound area data 204A includes fire magnitude data, which provides information on heat signatures and temperature variations across the fire-bound area 304. The fire-bound area data 204A allows the system to identify hotspots, where the fire intensity is highest among fire intensities of other spots in the fire-bound area 304, enabling the prioritization of firefighting efforts. In an example, the image data is received from the at least one aerial vehicle of the plurality of aerial vehicles 206. For instance, the at least one aerial vehicle includes a sensor configured to take high-resolution imagery or video, offering a detailed view of the fire's extent, the surrounding terrain, and any nearby infrastructure associated with the fire-bound area 304. In addition, the system 202 may receive environmental data associated with a geographical location where the fire is present. The environmental data includes wind speed and direction within the fire-bound area 304. The system 202 utilizes the environmental data to forecast the speed and a direction of the fire, as the wind may influence a rate of spread and direction of the fire. In an example, the environment data includes the humidity level associated with the fire-bound area 304. The humidity level affects fire behavior. Further, environment data includes the gas and chemical data that includes the concentration of hazardous gases such as carbon monoxide (CO), carbon dioxide (CO₂), methane, and compounds released from the fire.

In an embodiment, the fire-bound area data 204A includes the geospatial data. The geospatial data includes information about the terrain, such as elevation, vegetation density, and any potential natural or man-made firebreaks. In an example, the geospatial data includes details about buildings, infrastructure, and other assets within the fire-bound area 304. In an embodiment, the fire-bound area data 204A includes fire magnitude data. In an example, the fire magnitude data includes measurements of flame height, and the energy release rate associated with the fire. The fire magnitude data is utilized for analyzing the dynamics of the fire and predicting the future behavior of the fire within the fire-bound area data 204A. Additionally, the fire magnitude data provides information on ignition points and areas that may experience secondary fires due to embers or heat transfer.

At 410, an AI model application operation is executed. In the AI model application operation, the system 202 is configured to apply the AI model 202A to the fire-bound area data 204A. By way of example, and not by limitation, the AI model 202A is utilized to analyze the fire-bound area data 204A received from the at least one aerial vehicle of the plurality of aerial vehicle 206. The system 202 applies the AI model 202A to process and interpret the image data, the environmental data, the geospatial data, and the fire magnitude data to guide the deployment of aerial vehicles for extinguishing the fire within the fire-bound area 304. In an example, the AI model 202A includes a computer vision algorithm which includes a range of techniques and algorithms that enable image classification, object detection, and image segmentation. In an example, the AI model 202A utilizes techniques such as, but not limited to, deep learning techniques, such as convolutional neural networks (CNNs). In an example, the AI model 202A identifies features in the image data received from the at least one aerial vehicle. The features include, but is not limited to, fire height, fire intensity, fire direction, type of fire, fire hotspots, fire boundaries, and structural damage. In an example, the AI model 202A applies image segmentation techniques to distinguish fire-bound area 304 from safe areas, and object detection algorithms for identifying infrastructure, people, or animals at risk in the vicinity of the fire-bound area 304.

In an embodiment, the AI model 202A includes predictive analytics models, such as, but not limited to, time-series forecasting algorithms and regression models. The AI model 202A is configured to process the environmental data to predict the direction and spread of the fire. The AI model 202A continuously updates predictions as new fire-bound area data is received, allowing for dynamic and real-time fire behavior predictions. In an embodiment, the AI model 202A may include Geographic Information System (GIS) based models and spatial data analysis techniques. The AI model 202A is configured to process the geospatial data to map the progression of the fire in real-time, overlaying with geospatial features such as roads, buildings, and water sources.

In an embodiment, the AI model 202A processes the fire magnitude data to assess the severity and intensity of the fire within the fire-bound area 304, identifying areas that require immediate attention. In an example, the AI model 202A utilizes algorithms, such as, but not limited to, classification models, which categorizes fire intensity into different levels, ranging from low to extreme, and recommend corresponding firefighting strategies. The AI model 202A predicts future fire behavior, estimating when and where the fire will likely spread next in the vicinity of the fire-bound area 304. For example, when the AI model 202A identifies hotspots, the environmental data may be used to predict whether those areas are likely to spread, while geospatial data may be used to determine flight paths for providing access to the fire-bound area 304 for the set of aerial vehicles 306 of the plurality of aerial vehicles 206. The system 202 compiles this information to generate strategies for deploying the set of aerial vehicles 306 of the plurality of aerial vehicles 206, determining the high-priority fire hotspots, and selecting the acoustic frequency associated with each aerial vehicle of the set of aerial vehicles 306 based on the fire-bound area data 204A.

By way of example, and not by limitation, the AI model 202A includes clustering or pathfinding algorithms. The AI model 202A is configured to determine a route for aerial vehicle navigation, helping to avoid obstacles and plan efficient flight paths to the fire-bound area 304.

Referring to FIG. 4B, the block diagram 400B for the generation of the set of control instructions 202B associated with the set of aerial vehicles 306 is illustrated. FIG. 4B is explained in conjunction with elements from FIG. 1, FIG. 2, FIG. 3 and FIG. 4. With reference to FIG. 4B, the operations may start at 412.

At 412, a requirement data determination operation is executed. In the requirement data determination operation, the system 202 is configured to determine the requirement data 204B to acoustically extinguish the fire within the fire-bound area 304. The requirement data 204B is determined based on the application of the AI model 202A to the fire-bound area data 204A. The requirement data 204B is indicative of a count associated with the set of aerial vehicles 306 of the plurality of aerial vehicles 206 and one or more operating parameters associated with each aerial vehicle of the set of aerial vehicles 306.

By way of example, and not by limitation, the system 202 determines the requirement data 204B based on the application of the AI model 202A on the fire-bound area data 204A. The requirement data 204B is determined to facilitate the acoustical extinguishing of the fire within the fire-bound area 304.

In an embodiment, the requirement data 204B includes a count associated with a set of aerial vehicles 306 for extinguishing the fire within the fire-bound area 304. The count is determined based on factors such as, but not limited to, the spread of fire, the intensity of the fire, the spread rate of the fire, and the geographic extent associated with the fire-bound area 304. In an embodiment, the requirement data 204B includes the count of the number of aerial vehicles from the plurality of aerial vehicles 206 needed for extinguishing the fire within the fire-bound area 304. In an example, the system 202 is configured to determine the requirement data 204B to ensure comprehensive coverage of the fire-bound area 304. In addition, the requirement data 204B includes one or more operating parameters associated with each aerial vehicle of the set of aerial vehicles 306. The one or more operational parameters include a geographical location for a deployment of each aerial vehicle of the set of aerial vehicles 306 and/or an acoustic frequency for the operation of each aerial vehicle of the set of aerial vehicles 306. In an example, the one or more operational parameters indicate the positioning of each aerial vehicle of the set of aerial vehicles 306 above the fire-bound area 304. The one or more operational parameters indicate the geographical location for the deployment of each aerial vehicle of the set of aerial vehicles 306. The location data is determined to assign specific segments of the fire-affected area to individual aerial vehicles or groups thereof. This allocation of the geographical location is determined based on priority zones identified through fire-bound area data 204A analysis, ensuring that critical areas, such as, but not limited to, infrastructure or densely populated regions within the fire-bound area 304.

In an example, the one or more operational parameters include the flight path of each aerial vehicle of the set of aerial vehicles 306. For instance, the one or more operational parameters include, but is not limited to, the flight paths, geographic coordinates, and altitude levels for each aerial vehicle of the set of aerial vehicles 306, ensuring precise targeting of the fire-bound area 304. In an embodiment, the one or more operational parameters include an acoustic frequency for the operation of each aerial vehicle of the set of aerial vehicles 306. In an example, the one or more operational parameters include the frequency, amplitude, and emission patterns of acoustic waves to be generated by each aerial vehicle of the set of aerial vehicles 306. The acoustic parameters are dynamically adjusted in real-time to maximize the disruption of the fire's combustion process within the fire-bound area 304.

Additionally, the requirement data 204B specifies the payload configuration for each aerial vehicle of the set of aerial vehicles 306. This includes details regarding the acoustic modules and any supplementary equipment, such as sensors or communication devices associated with each aerial vehicle of the set of aerial vehicles 306. The one or more operational parameters include timing and synchronization parameters to ensure the coordinated operation of the set of aerial vehicles 306. For instance, the one or more operational parameters define the timing intervals, emission durations, and synchronization requirements for acoustic waves. In an example, the one or more operational parameters include energy resource data for each of the set of aerial vehicles 306 to complete the fire extinguishing in the fire-bound area 304 without interruption.

At 414, a set of control instructions generation operation is executed. In the set of control instructions generation operation, the system 202 is configured to generate the set of control instructions 202B based on the requirement data 204B. The set of control instructions 202B is associated with an operation of each aerial vehicle of the set of aerial vehicles 306 to acoustically extinguish the fire within the fire-bound area 304.

By way of example, and not by limitation, the set of control instructions 202B corresponds to a specific set of commands generated by the system 202 to facilitate the operation of the set of aerial vehicles 306 for acoustically extinguishing the fire within the fire-bound area 304. The generation of the set of control instructions 202B is a step that translates the analyzed requirement data 204B into actionable directives, ensuring the precise execution of the firefighting operation within the fire-bound area 304. The set of control instructions 202B is associated with each aerial vehicles of the set of aerial vehicles 306. For instance, the set of control instructions 202B, includes navigation, payload deployment, and acoustic wave emission, ensuring that each of the set of aerial vehicles 306 operates cohesively to extinguish the fire within the fire-bound area 304.

In an embodiment, the set of control instructions 202B includes one or more control instructions including navigation instructions and altitude levels instructions for each aerial vehicle of the set of aerial vehicles 306. The navigation instructions are designed to optimize the set of aerial vehicles 306 coverage within the fire-bound area 304 while avoiding obstacles such as buildings, trees, or rugged terrain. In an example, the set of control instructions 202B includes the acoustic emission instructions associated with each of the set of aerial vehicles 306, which define the specific characteristics of the acoustic waves to be generated by each aerial vehicle of the set of aerial vehicles 306. This instruction includes the frequency, amplitude, duration, and pattern of acoustic waves, tailored to disrupt the fire's combustion process completely. The system 202 ensures that these instructions are synchronized across the set of aerial vehicles 306 to create a cumulative acoustic effect that maximizes firefighting efficacy.

Additionally, the control instructions dynamically adjust these parameters in real-time based on feedback from sensors or updated fire-bound area data 204A. In an example, the set of control instructions 202B includes directives related to payload operation. These instructions govern the activation, deployment, and management of the acoustic modules and any supplementary equipment, such as thermal cameras or environmental sensors, carried by the set of aerial vehicles 306. The set of control instructions 202B ensures that each aerial vehicle of the set of aerial vehicles 306 operates in alignment with the overall firefighting strategy and adapts to the specific conditions of the assigned fire zone within the fire-bound area 304.

Further, the set of control instructions 202B defines timing and coordination protocols to ensure synchronized operations among the set of aerial vehicles 306. These protocols specify the sequence and timing of acoustic emissions, enabling the aerial vehicles to function collaboratively to suppress the fire. In an example, the set of control instructions 202B allows seamless communication between the set of aerial vehicles 306 and the system 202, allowing for real-time updates and adjustments during the firefighting mission. The set of control instructions 202B includes energy management instructions, which dictate power usage and operational duration for each aerial vehicle of the set of aerial vehicles 306. These instructions ensure that the aerial vehicles utilize the energy resources efficiently, minimizing the risk of mission interruption due to power depletion. In scenarios requiring extended operations, the system 202 provides additional instructions for returning to the ground station 302.

At 416, a set of control instructions output operation is executed. In the set of control instructions output operation, the system 202 is configured to output the set of control instructions 202B associated with each aerial vehicle of the set of aerial vehicles 306.

By way of example, and not by limitation, the system 202 transmits the generated set of control instructions 202B to the control aerial vehicle 308 or each of the set of aerial vehicles 306. This step involves transmitting the operational directives, which have been tailored based on the requirement data 204B, to ensure the proper execution of the firefighting operation within the fire-bound area 304. For instance, the system 202 is configured to output the set of control instructions 202B including assigned tasks associated with each aerial vehicle of the set of aerial vehicles. The set of control instructions 202B is outputted to the control aerial vehicle 308 of the set of aerial vehicles 306. This involves transmitting instructions that are specific to each aerial vehicle, based on the assigned tasks, positioning, payload, and other operational parameters. The system 202 ensures that the outputted set of control instructions 202B are delivered in a format compatible with a control interface of each of the set of aerial vehicles 306, enabling seamless execution of the control instructions. The outputted set of control instructions 202B includes directives for navigation and positioning, specifying the geographic coordinates, flight paths, and altitude levels that each aerial vehicle must follow. These instructions are transmitted in real-time or as pre-programmed routes. Additionally, the outputted set of control instructions 202B defines the acoustic emission parameters for each aerial vehicle of the set of aerial vehicles 306. The system 202 outputs the set of control instructions 202B with precise timing to enable coordinated acoustic emissions across the set aerial vehicles 306, maximizing disruption of the combustion process. The outputted set of control instructions 202B also includes payload operation commands for the activation and utilization of onboard equipment. For instance, the system 202 outputs specific instructions for initiating acoustic modules, deploying sensors, or capturing data from the fire-bound area 304. These commands ensure that the aerial vehicle's payload is operated in alignment with the overall firefighting strategy.

At 418, a set of aerial vehicles control operation is executed. In the set of aerial vehicles control operation, the system 202 is configured to control the operation of each aerial vehicle of the set of aerial vehicles 306. The operation of each aerial vehicle of the set of aerial vehicles 306 is controlled based on the set of control instructions 202B. By way of example, and not by limitation, the controlling of the operation of each aerial vehicle includes the execution and real-time management of the operational tasks assigned to each aerial vehicle within the set of aerial vehicles 306. Further, the control aerial vehicle 308 associated with the set of aerial vehicles 306 is configured to control the operation of each aerial vehicle of the set of aerial vehicles 306 by continuously monitoring activities and dynamically adjusting functions based on the received set of control instructions 202B. The control of the set of aerial vehicles 306 includes controlling the operation the operation of the aerial vehicles 310, including navigation, acoustic wave emission, payload management, and communication. By adhering to the set of control instructions 202B, the system 202 ensures that each aerial vehicle of the set of aerial vehicles 306 performs designated tasks within the assigned fire zone in the fire-bound area 304. The system 202 controls the flight paths, altitude, and positioning of each aerial vehicle of the set of aerial vehicles 306 as in the set of control instructions 202B. The system 202 is configured to control the set of aerial vehicles 306 to ensure collision avoidance among the set of aerial vehicles 306 and with external obstacles. In an example, the system 202 governs the operation of acoustic modules associated with each aerial vehicle of the set of aerial vehicles 306, ensuring that the specified frequency, amplitude, duration, and emission pattern of acoustic waves are maintained. For instance, the system 202 is configured to control the operation of aerial vehicles including real-time synchronization of acoustic emissions among the set of aerial vehicles 306 to maximize disruption of the combustion process of the fire within the fire-bound area 304.

In an embodiment, the system 202 dynamically adjusts these acoustic parameters in response to sensor feedback or updated fire-bound area data 204A, ensuring continuous optimization of the firefighting effort. The system 202 controls the operation of the aerial vehicle's payload, including the activation and control of sensors, cameras, and other onboard equipment. This control ensures that the payload functions align with the firefighting strategy and provides real-time data to the system 202 for further analysis. For example, thermal cameras may be controlled to gather heat signatures of specific fire zones, while environmental sensors may monitor conditions such as temperature or air quality. The system 202 ensures that these payload operations do not interfere with the acoustic firefighting efforts. In an embodiment, the system 202 oversees the synchronized operation of each aerial vehicle of the set of aerial vehicles 306. For instance, the system 202 may control the sequencing and timing of acoustic emissions to create a cumulative effect or direct aerial vehicles to maintain specified distances to avoid overlapping tasks. The system 202 monitors and controls the energy usage of each aerial vehicle of the set of aerial vehicles 306. This includes monitoring battery levels, optimizing power consumption during flight, and initiating a return to the ground station 302 commands for recharging when required. The system 202 dynamically adjusts the operational intensity of the aerial vehicle based on the remaining energy capacity, ensuring mission continuity without compromising performance. The system 202 employs adaptive control mechanisms to respond to unforeseen changes or challenges during the firefighting mission. For example, if a new fire hotspot is detected, the system 202 reassigns tasks to the aerial vehicles, updating the control instructions in real time.

At 420, an acoustic wave generation operation is executed. In the acoustic wave generation operation, the system 202 is configured to generate the acoustic wave to acoustically extinguish the fire within the fire-bound area 304. The acoustic wave is generated based on the controlling of the operation of each aerial vehicle of the set of aerial vehicles 306.

By way of example, and not by limitation, the generation of the acoustic waves includes the production and emission of sound waves with specific acoustic frequencies to acoustically extinguish the fire within the fire-bound area 304. Each aerial vehicle in the set of aerial vehicles 306 is configured to generate the acoustic wave based on the set of control instructions 202B. The set of control instructions 202B ensures that the acoustic waves are generated in a coordinated manner among the set of aerial vehicles 306 so that the fire is extinguished. The acoustic wave is generated in accordance with the parameters defined in the set of control instructions 202B, which specify the frequency, amplitude, duration, and emission patterns to disrupt the fire's combustion process. The one or more operational parameters are dynamically adjusted during the firefighting operation based on the fire-bound area data 204A. The controlled acoustic wave is generated with a frequency range that targets the specific characteristics of the fire, such as the combustion frequency of the burning material. The amplitude of the acoustic wave is calibrated to deliver sufficient energy to destabilize the fire's flame structure, interrupting the supply of oxygen and disrupting the chemical reactions sustaining the fire within the fire-bound area 304. The duration and modulation of the acoustic wave are further optimized to enhance the extinguishing effect while minimizing energy consumption.

In an embodiment, each aerial vehicle of the set of aerial vehicles 306 includes an acoustic generation module is configured to generate sound waves at varying frequencies and amplitudes. In an example, the acoustic generation modules operate under the direct control of the aerial vehicle's onboard system, which receives commands from the control aerial vehicle 308, the system 202, or the ground station 302. The acoustic modules emit acoustic waves in specific patterns, such as pulsating or continuous emissions of waves, to maximize the impact on the fire within the fire-bound area 304. To achieve a cumulative effect, the generation of the acoustic waves is synchronized across the set of aerial vehicles 306. The control aerial vehicle 308 ensures the deployment of aerial vehicles within the fire-bound area 304 such that the acoustic waves from one aerial vehicle overlap or align in a manner that amplifies the impact on the fire within the fire-bound area 304. For instance, one or more aerial vehicles of the set of aerial vehicles 306 may generate waves at complementary frequencies or in phased patterns to target different aspects of the fire's combustion dynamics. The generation process is dynamically adapted in real-time to address changing fire conditions.

By way of example, and not by limitation, when the fire-bound area data 204A indicates an increase in flame intensity or a shift in the location of the fire within the fire-bound area 304, the control aerial vehicle 308 or the ground station 302 adjusts the frequency, amplitude, or emission direction of the acoustic waves accordingly to extinguishing the fire in the fire-bound area 304. This adaptability ensures that the firefighting operation remains suitable even in unpredictable scenarios. In an example, the system 202 manages the energy usage of the acoustic modules during the generation process. By optimizing the emission parameters, the system 202 ensures that each aerial vehicle in the set of aerial vehicles 306 utilizes energy resources efficiently, prolonging operational capability and reducing the need for frequent recharging or refueling. In an example, the acoustic waves are generated with high precision to ensure that the acoustic waves target only the fire-affected areas without causing damage to surround infrastructure or posing risks to nearby personnel. For instance, the system 202 continuously monitors the acoustic emissions to maintain safety and compliance with environmental standards.

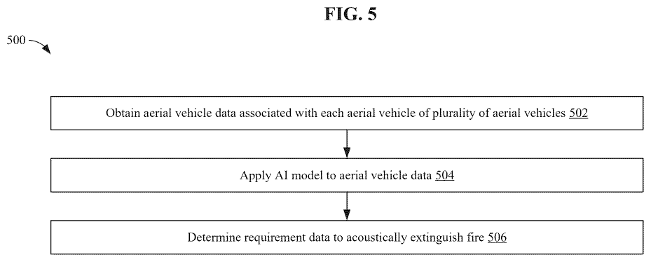

FIG. 5 is a diagram that illustrates a flowchart 500 for determination of the requirement data 204B to acoustically extinguish the fire, in accordance with an embodiment of the disclosure. FIG. 5 is explained in conjunction with elements of FIG. 1, FIG. 2, FIG. 3, FIG. 4A, and FIG. 4B. With reference to FIG. 5, there is shown a flowchart 500. The operations of the exemplary method may be executed by any computing system, for example, by the computer 102 of FIG. 1 or the system 202 of FIG. 2. The operations of the flowchart 500 may start at 502.

At 502, aerial vehicle data associated with each aerial vehicle of the plurality of aerial vehicles 206 is obtained. In an embodiment, the system 202 is configured to obtain aerial vehicle data associated with each aerial vehicle of the plurality of aerial vehicles 206. The aerial vehicle data includes one or more operating characteristics of each aerial vehicle of the plurality of aerial vehicles 206.

In an embodiment, the system 202 is configured to obtain the aerial vehicle data associated with each aerial vehicle of the plurality of aerial vehicles 206. The system 202 is configured to obtain the aerial vehicle data corresponding to the one or more operating characteristics associated with each aerial vehicle of the plurality of aerial vehicles 206 deployed in the fire-bound area 304 or the present at the ground station 302. The aerial vehicle data includes one or more operating characteristics of each aerial vehicle of the plurality of aerial vehicles 206, such as, but not limited to, operating altitude, operating velocity, flight path adherence, energy levels, battery characteristics, operating capacity, acoustic module performance, payload activity, and communication status.

At 504, the AI model 202A is applied to the aerial vehicle data. In an embodiment, the system 202 is configured to apply the AI model 202A to the aerial vehicle data. In an embodiment, the system 202 utilizes the AI model 202A to analyze, interpret, and derive actionable insights from the aerial vehicle data. This enables to understand operational characteristics and capabilities of each of the plurality of aerial vehicles 206 to align with the firefighting strategy.

At 506, the requirement data 204B is determined to acoustically extinguish the fire. In an embodiment, the requirement data 204B is determined based on the application of the AI model 202A to the aerial vehicle data. In an embodiment, the system 202 is configured to determine the requirement data 204B to acoustically extinguish the fire within the fire-bound area 304. The requirement data 204B is determined based on the application of the AI model 202A to the aerial vehicle data. In an example, the operational characteristics of the aerial vehicles are analyzed to calculate the parameters for the fire extinguishing using controlled acoustic waves. In an example, a height of the fire may be high, such as 10 feet. In such a case, based on operating range or altitude of each of the plurality of aerial vehicles 206, the set of aerial vehicles 306 may be selected. The selected set of aerial vehicles 306 may have an operating range or altitude higher than 10 feet. In an example, based on a maximum frequency generated by each of the plurality of aerial vehicles 206, the set of aerial vehicles 306 may be selected to generate the controlled wave for extinguishing the fire.

In this manner, the requirement data for extinguishing the fire is generated based on the operating characteristics or aerial vehicle data of each of the plurality of aerial vehicles 206. This may ensure that the requirement data for extinguishing the fire is realistically or practically executable with minimal stress on the aerial vehicles.

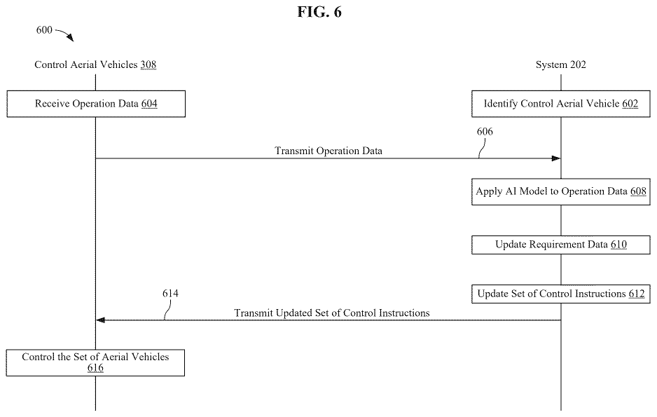

FIG. 6 is a diagram that illustrates a sequence diagram 600 that depicts controlling of the control aerial vehicle 308 to acoustically extinguish the fire, in accordance with an embodiment of the disclosure. FIG. 6 is explained in conjunction with elements of FIG. 1, FIG. 2, FIG. 3, FIG. 4A, FIG. 4B and FIG. 5. The sequence diagram 600 may include the system 202 and the control aerial vehicle 308. The sequence diagram 600 may depict operations performed by control aerial vehicle 308, system 202, and the processor set 114.

At 602, the control aerial vehicle 308 is identified. In an embodiment, the system 202 is configured to identify the control aerial vehicle 308 from the set of aerial vehicles 306. In an example, the system 202 is configured to receive control aerial vehicle data associated with the control aerial vehicle 308.

In an example, through a collaborative selection process, each aerial vehicle of the set of aerial vehicles 306 evaluates various parameters, such as battery life, sensor functionality, and current mission objectives, to determine which aerial vehicle is best suited to assume the role of the control aerial vehicle 308. This selection is based on criteria that ensure required performance and reliability, allowing the control aerial vehicle to lead the operation and manage the aerial vehicles 310 as required. Once identified, the control aerial vehicle 308 takes charge of coordinating data collection, communication, and task assignments among the remaining aerial vehicles 310 of the set of aerial vehicles 306. This hierarchical structure enhances operational efficiency. In an embodiment, the system 202 is configured to determine the control vehicle data. Each aerial vehicle of the set of aerial vehicles 306 coordinates to select the control aerial vehicle 308 from the set of aerial vehicles 306.

In an example, the system 202 is configured to identify one or more control aerial vehicles (such as the control aerial vehicle 308) from the set of aerial vehicles 306. In an example, the AI model 202A may be deployed on the control aerial vehicle 308. In an embodiment, the control aerial vehicle 308 is equipped with capabilities to connect with the ground station 302, facilitating real-time communication and data exchange. This connection allows for the transmission of critical information regarding the status and positioning of all aerial vehicles of the set of aerial vehicles 306 involved in the firefighting effort. Additionally, the control aerial vehicle 308 is configured to determine the acoustic wave frequency associated with each aerial vehicle in the set of aerial vehicles 306. By assessing the acoustic wave frequencies, the control aerial vehicle 308 optimizes the acoustic wave output to extinguish the fires, ensuring that the each of the aerial vehicles of the set of aerial vehicles 306 operates cohesively and efficiently to address the emergency. This coordinated approach enhances the overall operation of the set of aerial vehicles 306 in managing fire incidents. The control aerial vehicle 308 may be configured to determine the geographic location of the each of the aerial vehicles of the set of aerial vehicles 306 within the fire-bound area 304. Further, the control aerial vehicle 308 may be configured to connect with the ground station 302. Further, the control aerial vehicle may be configured to determine the acoustic wave frequency associated with each aerial vehicles of the set of aerial vehicles 306.

At 604, the control aerial vehicle 308 is configured to receive operation data. In an embodiment, the operation data includes details such as, but not limited to, flight path, altitude, speed, acoustic wave emission characteristics, and energy consumption metrics. In an example, the control aerial vehicle 308 is configured to receive the operation data associated with operation of each of the set of aerial vehicles 306. The operation data may indicate current status of the operation of the set of aerial vehicles 306 for extinguishing the fire. The operation data is collected and processed by the system 202 through communication with the control aerial vehicle 308, which monitors the performance of each aerial vehicle of the set of aerial vehicles 306 in real-time. By receiving the operation data, the control aerial vehicle 308 ensures that each aerial vehicle of the set of aerial vehicles 306 operates in alignment with the firefighting objectives and adapts to changing environmental conditions. The operational data may include, but is not limited to, current operating state of an aerial vehicle, temperature and fire data associated with a zone in which the aerial vehicle is operating, sensor reading collected by the aerial vehicle during the operation, and any critical event (such as low battery, system failure, etc.) data associated with the aerial vehicle.

At 606, the operation data is transmitted. In an embodiment, the operation data associated with the operation of each aerial vehicle of the set of aerial vehicles 306 is transmitted by the control aerial vehicle 308 to the system 202. In an embodiment, the system 202 is configured to receive the operation data associated with each of the set of aerial vehicles 306.

At 608, the AI model 202A is applied to the operation data. In an embodiment, the system 202 is configured to apply the AI model 202A to the operation data. In an embodiment, the application of AI model 202A enables the system 202 to analyze and process the received operation data. The AI model 202A is configured to interpret the operation data, which provides insights into the performance of each aerial vehicle in the set of aerial vehicles 306. By applying the AI model 202A to the operation data, the system 202 identifies patterns, trends, and correlations to detect anomalies, predict potential issues, and optimize the deployment of the aerial vehicles in the set of aerial vehicles 306 in real-time. The application of the AI model 202A is a critical step in the decision-making process and enables the system 202 to respond dynamically to changing conditions and adapt to the evolving fire scenario within the fire-bound area 304.

At 610, the requirement data 204B is updated. In an embodiment, the system 202 is configured to update the requirement data 204B based on the application of the AI model 202A to the operation data. For instance, if the operational data received from the control aerial vehicle 308 indicates that the acoustic wave frequency produced by a first aerial vehicle in the set of aerial vehicles 306 is insufficient for extinguishing the fire within the fire-bound area 304, the system 202 will update the requirement data 204B accordingly. This update may include modifying the acoustic wave frequency parameters for the first aerial vehicle to enhance the firefighting capabilities of the set of aerial vehicles 306. By doing so, the system 202 ensures that the aerial vehicles adapt the operational strategies to meet the specific needs of the fire suppression effort.

Furthermore, if the operational data reveals that a second aerial vehicle within the set of aerial vehicles 306 is experiencing low battery levels, the system 202 is configured to update the requirement data 204B to reflect this condition. The updating of the requirement data 204B may include reallocating tasks among the set of aerial vehicles 306, scheduling a replacement aerial vehicle from the plurality of aerial vehicles 206 to take over, or prioritizing the recharging of the low-battery second aerial vehicle. This proactive updating of requirement data 204B is ensures the efficiency of the set of aerial vehicles 306 during firefighting operations.

The continuous updating of the requirement data 204B enables the system 202 to respond swiftly to changing conditions within the fire-bound area 304. By leveraging real-time data and AI-driven insights, the system 202 ensures that the aerial vehicles are equipped with the capabilities to address the evolving dynamics of the fire within the fire-bound area 304. This adaptive approach of updating the requirement data 204B enhances the operation of the aerial vehicles and also contributes to a more strategic allocation of resources in firefighting efforts.

At 612, the set of control instructions 202B is updated. In an embodiment, the system 202 is configured to update the set of control instructions 202B based on the updated requirement data. In an example, the system 202 updates the set of control instructions 202B based on the updated requirement data generated in the step 608. In an example, the system 202 analyzes the updated requirement data to identify changes in the set of control instructions 202B. For instance, if the updated requirement data indicates that a specific aerial vehicle of the set of aerial vehicles 306 needs to be adjusted to the flight path to avoid obstacles or optimize the acoustic wave, the system 202 will take this into account and update the set of control instructions 202B. In an embodiment, Based on the analysis of the updated requirement data, the system 202 updates the set of control instructions 202B. The updating of the set of control instructions 202B includes altering parameters associated with one or more aerial vehicles of the set of aerial vehicles 306. The parameter may include, but is not limited to, altitude, speed, or the timing of acoustic wave output. For example, if the updated requirement data shows that a specific area within the fire-bound area 304 requires a higher frequency of the acoustic wave frequency due to rapid fire spread within the fire-bound area 304, the control instructions for the aerial vehicle of the set of the aerial vehicles responsible for the specific area will be adjusted accordingly.

In an example, the requirement data 204B indicates that a specific aerial vehicle of the set of aerial vehicles 306 is not covering the fire-bound area 304, the system 202 may initiate updates to the set of control instructions 202B. For instance, if a current acoustic wave frequency of the specific aerial vehicle of the set of aerial vehicles 306 is insufficient to disrupt the fire's thermal dynamics as needed, the system 202 adjusts the frequency or intensity of these acoustic waves to enhance the operation of extinguishing the fire within the fire-bound area 304. The set of control instructions 202B is updated to increase the frequency of the acoustic waves emitted by the specific aerial vehicle of the set of aerial vehicles 306. This updating of the set of control instructions 202B allows the acoustic waves to interact with the fire, potentially improving the ability of the set of aerial vehicles 306 to suppress it.

For example, if the system 202 determines that the specific aerial vehicle of the set of aerial vehicles 306 operates at a lower altitude and needs a broader coverage area, then the system 202 generates the updated set of control instructions that instruct the specific aerial vehicle to change position to a higher altitude to achieve a broader coverage area with the acoustic waves. The specific aerial vehicle then increases altitude and also transmits the newly adjusted acoustic wave frequency to maximize the impact on the fire, ensuring that the specific aerial vehicle covers the designated area while minimizing response delays.

At 614, the updated set of control instructions is transmitted. In an embodiment, the system 202 is configured to transmit the updated set of control instructions to the control aerial vehicle 308. In an embodiment, the control aerial vehicle 308 receives the updated set of control instructions from the system 202. In an embodiment, the ground station 302 is configured to transmit the updated set of control instructions to the control aerial vehicle. In an example, the updated set of control instructions may be used to the control the response of the set of aerial vehicles 306 to the fire within the fire-bound area 304. In an embodiment, when the control aerial vehicle 308 receives the updated set of control instructions, the control aerial vehicle 308 promptly implements the changes in the operational parameter of the set of aerial vehicles 306, allowing the set of aerial vehicles 306 to adjust flight path, altitude, and operational parameters as required. This real-time adaptability is needed for optimizing firefighting efforts. In an example, the ground station 302 is configured to transmit the updated set of control instructions to the control aerial vehicle 308 of the set of aerial vehicles 306. This ensures that each aerial vehicle of the set of aerial vehicles 306 operates with the latest information, enhancing coordination and efficiency during firefighting operations. By maintaining a seamless flow of updated instructions, the system 202 ensures that the set of aerial vehicles responds to changing conditions in the fire-bound area 304, ultimately improving the performance in combating fires.

At 616, the control aerial vehicle 308 is controlled based on the updated set of control instructions. In an embodiment, the system 202 is configured to control the control aerial vehicle 308 based on the updated set of control instructions. Initially, the updated set of control instructions is transmitted to the control aerial vehicle 308, ensuring the control aerial vehicle 308 receives the latest operational directives. In an example, when the control aerial vehicle 308 receives the updated set of control instructions, the control aerial vehicle 308 is programmed to adjust the one or more operational parameters associated with itself and/or the set of aerial vehicles 306. For example, if the updated set of control instructions indicates a change in the target area for surveillance or firefighting, then the control aerial vehicle 308 modifies the one or more operational parameters associated with one or more aerial vehicles of the set of aerial vehicles 306. The modification of the one or more operational parameters includes flight path and altitude aligning with the updated set of control instructions.

In an example, where the control aerial vehicle 308 is deployed to monitor a wildfire. If the fire spreads unexpectedly, the system 202 may transmit an updated set of control instructions to redirect the set of aerial vehicles to a new hotspot. The set of aerial vehicles, upon receiving the updated set of control instructions from the control aerial vehicle 308, autonomously adjusts the trajectory and begins monitoring the new area. This real-time control enhances the aerial operations, allowing for a more coordinated and efficient response to emergencies.

In an embodiment, the system 202 is configured to control the control aerial vehicle 308 to transmit at least a part of the updated set of control instructions to each aerial vehicle of the set of aerial vehicles 306. In an example, the control aerial vehicle 308 is controlled to transmit at least a part of the updated set of control instructions to each aerial vehicle of the set of aerial vehicles 306. In an example, the control aerial vehicle 308 ensures that each aerial vehicle of the set of aerial vehicles 306 is synchronized and operating with the most current information received from the system 202, which is critical during dynamic situations such as, but not limited to, firefighting or search and rescue missions.

For instance, consider a scenario where the set of aerial vehicles 306 are deployed to combat a rapidly spreading wildfire. The control aerial vehicle 308, equipped with advanced communication capabilities, receives the updated set of control instructions from the system 202 regarding changes in the fire's behavior, target zones for acoustically extinguishing the fire, or adjustments in flight patterns to avoid hazardous areas. The control aerial vehicle 308 immediately transmits relevant portions of the updated instructions to all aerial vehicles 310 in the set of aerial vehicles 306. For example, if the control aerial vehicle 308 identifies that a particular quadrant of the fire has intensified and requires immediate attention, the control aerial vehicle 308 quickly sends out a command to all aerial vehicles of the set of aerial vehicles 306, instructing to redirect the efforts to that specific area.

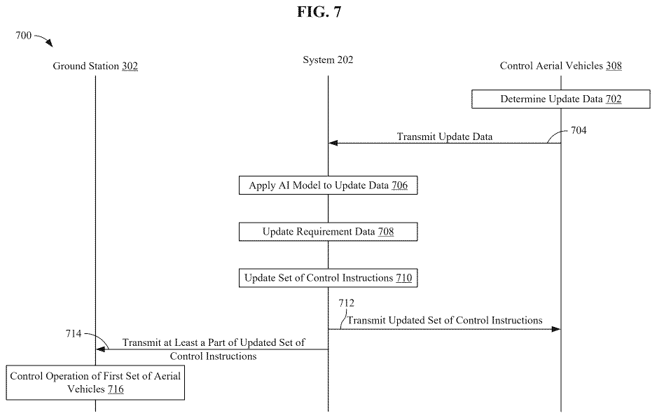

FIG. 7 is a diagram that illustrates a sequence diagram 700 that depicts the controlling of aerial vehicles to acoustically extinguish the fire based on updated data associated with the fire, in accordance with an example embodiment. FIG. 7 is explained in conjunction with elements of FIG. 1, FIG. 2, FIG. 3, FIG. 4A, FIG. 4B, FIG. 5, and FIG. 6. The sequence diagram 700 may include the system 202, the control aerial vehicle 308, and the ground station 302. The sequence diagram 700 may depict operations performed by control aerial vehicle 308, system 202, and the processor set 114.

At 702, the updated data is determined. In an embodiment, the control aerial vehicle 308 is configured to determine update data from at least one of the set of aerial vehicles 306. The update data is associated with the fire within the fire-bound area 304. In an embodiment, the control aerial vehicle 308 is configured to determine the update data from at least one of the set of aerial vehicles 306. In an example, the update data provides real-time insights into the fire conditions within the fire-bound area 304. For example, an aerial vehicle of the set of aerial vehicles 306 detects changes in temperature, smoke density, or indicators of fire behavior within the fire-bound area 304. In an example, if the update data indicates that the fire condition in the fire-bound area 304 is increasing, then the control aerial vehicle 308 uses this information to make informed decisions about resource allocation and strategic planning. The control aerial vehicle 308 may decide to redirect the aerial vehicles to focus on containment efforts in the most affected areas, thereby enhancing the firefighting operation.

At 704, update data is transmitted. In an embodiment, the control aerial vehicle 308 is configured to transmit the update data associated with the fire within the fire-bound area 304. In an example, the control aerial vehicle 308 is configured to transmit the image data received from the at least one of the set of aerial vehicles 306 to the system 202. The control aerial vehicle 308 transmits the collected update data to the system 202. The information received includes various metrics, such as the intensity of the fire, the direction of spread of the fire, and any changes in environmental conditions that could impact firefighting efforts. In an example, the control aerial vehicle 308 transmits the update data including image data about fire hotspots using a combination of advanced communication technologies and onboard sensors. Typically, the control aerial vehicle 308 is equipped with a communication system that allows the control aerial vehicle 308 to receive data from the set of aerial vehicles 306 deployed in the fire-bound area 304. This comprehensive data transmission enables a coordinated response, ensuring that resources are allocated efficiently to combat the fire as required. The ability to identify new hotspots quickly significantly impacts the success of firefighting efforts, ultimately leading to better outcomes in protecting lives, property, and the environment. For example, the update data corresponds to updated fire-bound area data 204A that is received in real time or near real time based on current condition or advances in the fire.

At 706, the AI model 202A is applied to the update data. In an embodiment, the system 202 is configured to apply the AI model 202A to the update data associated with the fire within the fire-bound area data 204A. In an example, the AI model 202A analyzes the changes in the fire in the fire-bound area data 204A based on the update data. For instance, the AI model 202A analyzes the update data to identify new hotspots that may not have been previously detected. The AI model 202A recognizes patterns and changes in the fire over a period of time during which the extinguishing operation is being applied to the fire.

At 708, the requirement data 204B is updated based on the application of AI model 202A to the update data. In an embodiment, the system 202 is configured to update the requirement data 204B based on the application of the AI model 202A to the update data. In an example, when the AI model 202A identifies new hotspots within the fire-bound area 304 that require immediate attention, the requirement data is updated to indicate additional aerial vehicles from the plurality of aerial vehicles 206 to address the escalating fire threat. Additionally, the AI model 202A evaluates the operational status of the deployed set of aerial vehicles 306, including battery levels. If certain aerial vehicles of the set of aerial vehicles 306 are found to have low battery capacity, the system 202 prioritizes the return for recharging or maintenance, thereby optimizing resource management. This dynamic updating of the requirement data 204B allows system 202 to make informed decisions regarding resource allocation, ensuring aerial support to combat the fire. By continuously integrating real-time data and AI model 202A analysis, the system 202 enhances overall situational awareness and responsiveness in managing fire incidents, ultimately improving safety and operational outcomes.

At 710, the set of control instructions 202B is updated based on the updated requirement data 204B. In an embodiment, the system 202 is configured to update the set of control instructions 202B based on the updated requirement data. This process is needed to ensure that the operational response to the fire is timely. The updated requirement data 204B, which reflects the current assessment of fire hotspots and the status of the set of aerial vehicles 306, informs the actions that need to be taken by the aerial vehicles in the fire-bound area 304. For example, if the AI model 202A determines that additional aerial vehicles from the plurality of aerial vehicles 206 are required to address emerging hotspots, the set of control instructions 202B will be modified to instruct a deployment of the additional aerial vehicles to the identified locations or zones in the fire-bound area 304. Conversely, if certain aerial vehicles of the set of aerial vehicles 306 are deemed to have low battery levels, the control instructions are updated to instruct those aerial vehicles to return to the ground station 302 for recharging. This dynamic updating of control instructions 202B ensures that the aerial vehicles of the set of aerial vehicles 306 operate in alignment with the most current situational analysis. By continuously updating the set control instructions 202B based on updated requirement data, the system 202 enhances coordination among the set of aerial vehicles 306, optimizes resource deployment, and ultimately improves the firefighting operations in real-time.

At 712, an updated set of control instructions is transmitted. In an embodiment, the system 202 is configured to transmit the updated set of control instructions to the control aerial vehicle 308, the ground station 302, and/or each of the aerial vehicles being deployed. In an embodiment, based on the updated set of control instructions, the control aerial vehicle 308 is configured to control the set of aerial vehicles 306 and the additional aerial vehicles. In an example, the updated set of control instructions 202B is transmitted to the control aerial vehicle 308 through a secure communication link established. This communication typically utilizes radio frequencies or satellite links, ensuring real-time data transfer. The control aerial vehicle 308 continuously monitors the status of each aerial vehicle of the set of aerial vehicles 306 and sends the updated control instructions to adapt to changing conditions on the fire-bound area 304.

At 714, at least a part of the updated set of control instructions is transmitted. In an embodiment, the system 202 is configured to transmit the at least the part of the updated set of control instructions to the ground station 302. In an example, the ground station 302 may receive specific control instructions related to the additional aerial vehicles from the plurality of aerial vehicles 206. These instructions could detail the deployment of the one or more additional aerial vehicles within the fire-bound area 304, ensuring that the one or more additional aerial vehicles join the set of aerial vehicles 306 actively engaged in firefighting efforts. By receiving targeted control instructions, the ground station 302 facilitates the timely deployment of aerial resources, enhancing the overall firefighting strategy.

At 716, the operation of a first set of aerial vehicles of the plurality of aerial vehicles 206 is controlled. In an embodiment, the ground station 302 is configured to control the operation of the first set of aerial vehicles of the plurality of aerial vehicles 206. In an example, upon receiving the updated set of control instructions, the ground station 302 is configured to manage the deployment of the first set of aerial vehicles of the plurality of the aerial vehicles 206, directing to join the set of aerial vehicles 306 operating within the fire-bound area 304.

The ground station 302 accesses the situation in the fire-bound area 304. If the system 202 determines that the set of aerial vehicles 306 is insufficient to combat the fire, the ground station 302 initiates the deployment of additional aerial resources. This decision is based on real-time evaluations of the fire's magnitude, the available resources, and the operational capabilities of the aerial vehicles. By deploying the additional set of aerial vehicles, the ground station 302 enhances the firefighting efforts, ensuring that sufficient resources are allocated to extinguish the fire.

In an example, the ground station 302 may call back one or more aerial vehicles from the set of aerial vehicles 306. This action could be based on various factors, including fire magnitude data, which indicates a decrease in fire activity, or operational parameters such as fuel levels, and equipment status. By managing the deployment and recall of aerial vehicles, the ground station 302 ensures the resource utilization, enhancing the overall the firefighting operation. This dynamic approach allows for a flexible response to changing conditions, ultimately contributing to a more successful firefighting strategy.

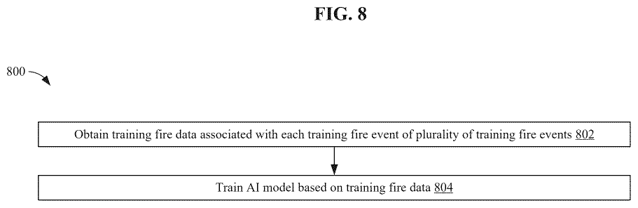

FIG. 8 is a diagram that illustrates a flowchart 800 for the training of the AI model 202A based on the training fire data, in accordance with an embodiment of the disclosure. FIG. 8 is explained in conjunction with elements from FIG. 1, FIG. 2, FIG. 3, FIG. 4A, FIG. 4B, FIG. 5, FIG. 6, and FIG. 7. With reference to FIG. 8, the operation may start at 802.

At 802, training fire data associated with each training fire event of the plurality of training fire events is obtained. In an embodiment, the system 202 is configured to obtain the training fire data associated with each training fire event of a plurality of training fire events. The training fire data comprises training intensity data, historical location data, historical environment data, historical extinguishing acoustic wave data, and historical deployment data.

The system 202 is configured to obtain the training fire data associated with each event in a plurality of training fire events. This dataset is used for training the AI model 202A to predict and manage fire scenarios. The training fire data includes the training intensity data, which includes quantitative measures of fire intensity at various stages of each event of the plurality of events, enabling the AI model 202A to differentiate between varying levels of fire severity. In an embodiment, the training fire data includes historical location data which provides geographical coordinates of each fire event, allowing the AI model 202A to understand the spatial distribution of fires and inform the deployment strategies of the set of aerial vehicles 306 of the plurality of aerial vehicles 206. Further, the training fire data includes the historical environment data. The historical environment data including environmental factors such as wind speed, humidity, temperature, and atmospheric pressure, help the AI model 202A to learn how these conditions influence fire behavior and the acoustic wave interventions.

Furthermore, the training data includes historical extinguishing acoustic wave data which records the specific frequencies and intensities of acoustic waves used in past control efforts, facilitating the determination of which acoustic parameters under various conditions. In an embodiment, the training fire data includes the historical deployment data, which includes information on aerial vehicles of the plurality of aerial vehicles 206 that were deployed during previous fire events, encompassing the positioning, coordination, and timing. This diverse dataset allows the system 202 to train a robust machine-learning model that continuously learns and adapts, ultimately enhancing the ability to efficiently manage and mitigate fire incidents.

At 804, the AI model 202A is trained based on the training fire data. In an embodiment, the system 202 is configured to train the AI model 202A based on the training fire data. In an embodiment, the training of the AI model 202A for fire control through the application of acoustic waves includes the integration of both supervised and unsupervised machine learning techniques. This allows the AI model 202A to provide nuanced decision-making in real-time fire scenarios, where various attributes such as fire location, intensity, and environmental conditions are beneficial.

In an embodiment, the training process of the AI model 202A begins with the collection of diverse input parameters. These parameters include but are not limited to, a location of the fire-bound area 304 derived from GPS data, real-time image data captured by the at least one aerial vehicle of the plurality of aerial vehicles 206, fire intensity and severity assessments, wind strength, and direction, moisture levels (including relative humidity and precipitation), and atmospheric pressure. This rich dataset forms the foundation for the AI model 202A, to learn the complex relationships between these variables and the impact on fire behavior.

In an embodiment, the AI model 202A is trained based on the supervised learning techniques, where the AI model 202A is fed labeled data that includes historical instances of fire events and the corresponding successful interventions using acoustic waves. By analyzing this data, the AI model 202A learns to predict the acoustic wave capacities for controlling fires of varying classes and intensities. This training phase helps establish a baseline understanding of how different factors influence fire dynamics the acoustic suppression.

In an embodiment, the AI model 202A is trained by unsupervised learning techniques to identify patterns and anomalies in the data that may not be immediately apparent. For instance, clustering algorithms may group similar fire scenarios, allowing the AI model 202A to recognize which conditions typically lead to successful extinguishment of the fire. This insight is particularly valuable for preparing artificial scenarios of fire, which may be simulated to train the system 202. In an embodiment, the architecture of the AI model 202A corresponds to a regression model using neural networks, allowing for the handling of multiple independent and dependent variables. As the AI model 202A learns continuously refines the predictions and tuning parameters based on new data, enhancing the ability to adapt to changing conditions in real time.

By way of example, and not by limitation, the output of the AI model 202A includes information such as the count of aerial vehicles from the plurality of aerial vehicles 206, to the relative positioning, and the output of the acoustic frequency of acoustic waves needed to combat the fire within the fire-bound area 304. This dynamic approach ensures that the set of aerial vehicles is deployed efficiently, generating the acoustic wave capacities tailored to specific fire scenarios. In an example, the training of the AI model 202A enhances the decision-making capabilities and enriches the fire extinguishing strategies for future incidents. By capturing the aerial vehicle experiences through datafication, the AI model 202A continuously evolves, leading to more responsive fire management solutions.

The present disclosure describes the application of the single AI model 202A to the fire-bound area data 204A associated with the fire, the aerial vehicle data associated with characteristics of each aerial vehicle of the plurality of aerial vehicles 206, and the operation data associated with the operation of each aerial vehicle of the set of aerial vehicles 306. However, this should not be construed as a limitation. In various example embodiments, different AI models may be trained to be applied to the fire-bound area data 204A, the aerial vehicle data and the operation data. The different AI models may determine parameter-specific requirement data based on corresponding input. Moreover, the requirement data may be determined based on, for example, weighted average of parameter-specific requirement data determined by each of the different AI models.

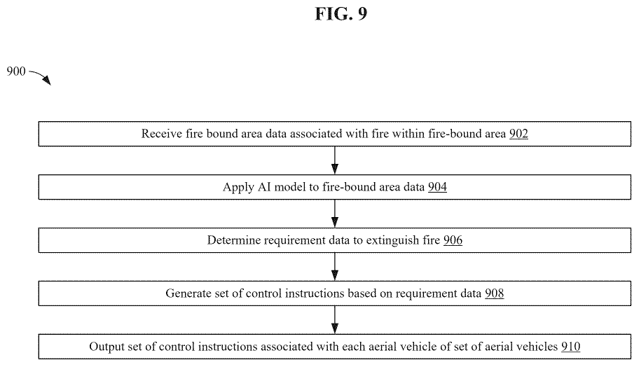

FIG. 9 is a diagram that illustrates a flowchart 900 of an exemplary method for the generation of the set control instructions 202B associated with the set of aerial vehicles to extinguish the fire, in accordance with an embodiment of the disclosure. FIG. 9 is explained in conjunction with elements of FIG. 1, FIG. 2, FIG. 3, FIG. 4A, FIG. 4B, FIG. 5, FIG. 6, FIG. 7 and FIG. 8. With reference to FIG. 9, there is shown a flowchart 900. The operations of the exemplary method may be executed by any computing system, for example, by the computer 102 of FIG. 1 or the system 202 of FIG. 2. The operations of the flowchart 900 may start at 902.

At 902, fire-bound area data 204A associated with a fire within a fire-bound area 304 is received. The fire-bound area data includes image data, environment data, geospatial data, and fire magnitude data. In an embodiment, the system 202 is configured to receive fire-bound area data 204A associated with a fire within a fire-bound area 304. The fire-bound area data includes image data, environment data, geospatial data, and fire magnitude data.

At 904, an AI model is applied to the fire-bound area data 204A. In an embodiment, the system 202 is configured to apply the AI model 202A to the fire-bound area data.

At 906, the requirement data 204B to extinguish the fire is determined. The requirement data 204B is determined based on the application of the AI model 202A to the fire-bound area data. The requirement data 204B is indicative of a count associated with a set of aerial vehicles 306 of a plurality of aerial vehicles 206 and one or more operating parameters associated with each aerial vehicle of the set of aerial vehicles 306. In an embodiment, the system 202 is configured to determine the requirement data 204B based on the application of the AI model 202A to the fire-bound area data 204A. The requirement data is indicative of a count associated with a set of aerial vehicles 306 of a plurality of aerial vehicles 206 and one or more operating parameters associated with each aerial vehicle of the set of aerial vehicles 306.

At 908, a set of control instructions 202B based on the requirement data is generated. The set of control instructions 202B is associated with an operation of each aerial vehicle of the set of aerial vehicles 306 to acoustically extinguish the fire within the fire-bound area 304. In an embodiment, the system 202 is configured to generate the set of control instructions 202B based on the requirement data 204B. The set of control instructions 202B is associated with an operation of each aerial vehicle of the set of aerial vehicles 306 to acoustically extinguish the fire.

At 910, the set of control instructions 202B associated with each aerial vehicle of the set of aerial vehicles 306 is outputted. In an embodiment, the system 202 is configured to output the set of control instructions 202B associated with each aerial vehicle of the set of aerial vehicles 306.

In various embodiments of the disclosure, a computer program product for generation of the set of control instructions 202B associated with the aerial vehicle is described. The computer program product includes a computer-readable storage medium having program instructions stored on the computer-readable storage media to perform operations. The operations include receiving fire-bound area data 204A associated with a fire within a fire-bound area 304. The fire-bound area data 204A comprises image data, environment data, geospatial data, and fire magnitude data. The operations further include applying the AI model 202A to the fire-bound area data 204A. The operations further include determining the requirement data 204B to extinguish the fire. The requirement data 204B is determined based on the application of the AI model 202A to the fire-bound area data 204A. The requirement data 204B is indicative of a count associated with the set of aerial vehicles 306 of the plurality of aerial vehicles 206 and one or more operating parameters associated with each aerial vehicle of the set of aerial vehicles 306. The operations further include generating a set of control instructions 202B based on the requirement data 204B. The set of control instructions 202B is associated with an operation of each aerial vehicle of the set of aerial vehicles 306 for the acoustic extinguishing of the fire. The operations further include outputting the set of control instructions 202B associated with each aerial vehicle of the set of aerial vehicles 306.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enables ordinary skill in the art to understand the embodiments disclosed herein.

What is claimed is:

1. A computer-implemented method, comprising:
receiving, by a computer, fire-bound area data associated with a fire within a fire-bound area, wherein the fire-bound area data comprises image data, environment data, geospatial data, and fire magnitude data;
applying, by the computer, an artificial intelligence (AI) model to the fire-bound area data;
determining, by the computer, requirement data to acoustically extinguish the fire, wherein the requirement data is determined based on the application of the AI model to the fire-bound area data, and wherein the requirement data is indicative of a count associated with a set of aerial vehicles of a plurality of aerial vehicles and one or more operating parameters associated with each aerial vehicle of the set of aerial vehicles;
generating, by the computer, a set of control instructions based on the requirement data, wherein the set of control instructions is associated with an operation of each aerial vehicle of the set of aerial vehicles to acoustically extinguish the fire; and
outputting, by the computer, the set of control instructions associated with each aerial vehicle of the set of aerial vehicles.

2. The computer-implemented method of claim 1, further comprising:
controlling, by the computer, the operation of each aerial vehicle of the set of aerial vehicles, wherein the operation of each aerial vehicle of the set of aerial vehicles is controlled based on the set of control instructions; and
generating, by the computer, an acoustic wave to acoustically extinguish the fire, wherein the acoustic wave is generated based on the controlling of the operation of each aerial vehicle of the set of aerial vehicles.

3. The computer-implemented method of claim 1, further comprising:
receiving, by the computer, location data associated with the fire within the fire-bound area;
generating, by the computer, control data for at least one aerial vehicle of the plurality of aerial vehicles, wherein the control data is generated based on the location data; and
controlling, by the computer, the at least one aerial vehicle based on the control data, wherein the at least one aerial vehicle is controlled to collect the fire-bound area data.

4. The computer-implemented method of claim 3, wherein the at least one aerial vehicle of the plurality of aerial vehicles comprises a plurality of sensors for collecting the fire-bound area data, and wherein the plurality of sensors comprises at least one of a thermal sensor, a gyroscope, an image sensor, or an anemometer.

5. The computer-implemented method of claim 1, further comprising:
obtaining, by the computer, aerial vehicle data associated with each aerial vehicle of the plurality of aerial vehicles, wherein the aerial vehicle data comprises one or more operating characteristics of each aerial vehicle of the plurality of aerial vehicles;
applying, by the computer, the AI model to the aerial vehicle data; and
determining, by the computer, the requirement data based on the application of the AI model to the aerial vehicle data.

6. The computer-implemented method of claim 1, wherein the one or more operating parameters associated with each aerial vehicle of the set of aerial vehicles comprises at least one of a geographical location for a deployment of each aerial vehicle of the set of aerial vehicles, or an acoustic frequency for the operation of each aerial vehicle of the set of aerial vehicles.

7. The computer-implemented method of claim 1, further comprising:
identifying, by the computer, a control aerial vehicle from the set of aerial vehicles, wherein each aerial vehicle of the set of aerial vehicles selects the control aerial vehicle;
receiving, by the computer, operation data associated with the operation of each aerial vehicle of the set of aerial vehicles, wherein the operation data is received from the control aerial vehicle;
applying, by the computer, the AI model to the operation data;
updating, by the computer, the requirement data based on the application of the AI model to the operation data;
updating, by the computer, the set of control instructions based on the updated requirement data; and
transmitting, by the computer, the updated set of control instructions to the control aerial vehicle.

8. The computer-implemented method of claim 7, further comprising:
controlling, by the computer, the control aerial vehicle based on the updated set of control instructions, wherein the control aerial vehicle is controlled to transmit at least a part of the updated set of control instructions to each aerial vehicle of the set of aerial vehicles.

9. The computer-implemented method of claim 7, further comprising:
receiving, by the computer, update data associated with the fire within the fire-bound area, wherein the update data is received from at least one of the set of aerial vehicles or the control aerial vehicle;
applying, by the computer, the AI model to the update data; and
updating, by the computer, the set of control instructions based on the application of the AI model to the update data.

10. The computer-implemented method of claim 1, further comprising:
obtaining, by the computer, training fire data associated with each training fire event of a plurality of training fire events, wherein the training fire data comprises training intensity data, historical location data, historical environment data, historical extinguishing acoustic wave data, and historical deployment data; and
training, by the computer, the AI model based on the training fire data.

11. The computer-implemented method of claim 1, wherein the environment data comprises at least one of temperature data, wind speed data, wind direction data, or humidity data.

12. A computer system, comprising:
a processor set;
one or more computer-readable storage media; and
program instructions stored on the one or more computer-readable storage media, the program instructions executable by the processor set to cause the processor set to:
receive fire-bound area data associated with a fire within a fire-bound area, wherein the fire-bound area data comprises image data, environment data, geospatial data, and fire magnitude data;
apply an AI model to the fire-bound area data;
determine requirement data to acoustically extinguish the fire, wherein the requirement data is determined based on the application of the AI model to the fire-bound area data, and wherein the requirement data is indicative of a count associated with a set of aerial vehicles of a plurality of aerial vehicles and one or more operating parameters associated with each aerial vehicle of the set of aerial vehicles;
generate a set of control instructions based on the requirement data, wherein the set of control instructions is associated with an operation of each aerial vehicle of the set of aerial vehicles to acoustically extinguish the fire; and
output the set of control instructions associated with each aerial vehicle of the set of aerial vehicles.

13. The computer system of claim 12, wherein the program instructions further cause the processor set to:
control the operation of each aerial vehicle of the set of aerial vehicles, wherein the operation of the set of aerial vehicles is controlled based on the set of control instructions; and
generate an acoustic wave to acoustically extinguish the fire, wherein the acoustic wave is generated based on the control of the operation of each aerial vehicle of the set of aerial vehicles.

14. The computer system of claim 12, wherein the program instructions further cause the processor set to:
receive location data associated with the fire within the fire-bound area;
generate control data for at least one aerial vehicle of the plurality of aerial vehicles, wherein the control data is generated based on the location data; and
control the at least one aerial vehicle based on the control data, wherein the at least one aerial vehicle is controlled to collect the fire-bound area data.

15. The computer system of claim 12, wherein the program instructions further cause the processor set to:
obtain aerial vehicle data associated with each aerial vehicle of the plurality of aerial vehicles, wherein the aerial vehicle data comprises one or more operating characteristics of each aerial vehicle of the plurality of aerial vehicles;
apply the AI model to the aerial vehicle data; and
determine the requirement data based on the application of the AI model to the aerial vehicle data.

16. The computer system of claim 12, wherein the program instructions further cause the processor set to:
identify a control aerial vehicle from the set of the set of aerial vehicles, wherein each aerial vehicle of the set of aerial vehicles selects the control aerial vehicle from the set of aerial vehicles;
receive operation data associated with the operation of each aerial vehicle of the set of aerial vehicles, wherein the operation data is received from the control aerial vehicle;
apply the AI model to the operation data;
update the requirement data based on the application of the AI model to the operation data;
update the set of control instructions based on the updated requirement data; and
transmit the updated set of control instructions to the control aerial vehicle.

17. The computer system of claim 16, wherein the program instructions further cause the processor set to:
control the control aerial vehicle based on the updated set of control instructions, wherein the control aerial vehicle is controlled to transmit at least a part of the updated set of control instructions to each aerial vehicle of the set of aerial vehicles.

18. The computer system of claim 16, wherein the program instructions further cause the processor set to:
receive update data associated with the fire within the fire-bound area, wherein the update data is received from at least one of the set of aerial vehicles or the control aerial vehicle;
apply the AI model to the update data; and
update the set of control instructions based on the application of the AI model to the update data.

19. The computer system of claim 12, wherein the program instructions further cause the processor set to:
obtain training fire data associated with each training fire event of a plurality of training fire events, wherein the training fire data comprises training intensity data, historical location data, historical environment data, historical extinguishing acoustic wave data, and historical deployment data; and
train the AI model based on the training fire data.

20. A computer-program product for generation of a set of control instructions to acoustically extinguish a fire, the computer-program product comprising:
one or more computer-readable storage media; and
program instructions stored on the one or more computer-readable storage media to perform operations comprising:
receiving fire-bound area data associated with the fire within a fire-bound area, wherein the fire-bound area data comprises image data, environment data, geospatial data, and fire magnitude data;
applying an AI model to the fire-bound area data;
determining requirement data to acoustically extinguish the fire, wherein the requirement data is determined based on the application of the AI model to the fire-bound area data, and wherein the requirement data is indicative of a count associated with a set of aerial vehicles of a plurality of aerial vehicles and one or more operating parameters associated with each aerial vehicle of the set of aerial vehicles;
generating the set of control instructions based on the requirement data, wherein the set of control instructions is associated with an operation of each aerial vehicle of the set of aerial vehicles to acoustically extinguish the fire; and
outputting the set of control instructions associated with each aerial vehicle of the set of aerial vehicles.
